(19) United States
(12) Patent Application Publication
(10) Pub. No.: US 2015/0349692 A1
(43) Pub. Date: Dec. 3, 2015

(54) SOLAR ENERGY UTILIZATION SYSTEM, AND COOL BOX, AIR CONDITIONER OR PUMP INCLUDED THEREIN

(71) Applicant: SHARP KABUSHIKI KAISHA, Osaka-shi, Osaka (JP)

(72) Inventors: Akihide SHIBATA, Osaka (JP); Kohtaroh KATAOKA, Osaka (JP); Shuji WAKAIKI, Osaka (JP); Masaru NOMURA, Osaka (JP); Takeshi SHIOMI, Osaka (JP); Hiroshi IWATA, Osaka (JP); Masashi IMADE, Osaka (JP); Akio MIYATA, Osaka (JP); Shinichi ABE, Osaka (JP)

(73) Assignee: SHARP KABUSHIKI KAISHA, Osaka-shi, Osaka (JP)

(21) Appl. No.: 14/759,690

(22) PCT Filed: Dec. 13, 2013
(86) PCT No.: PCT/JP2013/083427

§ 371 Date: Jul. 8, 2015

(30) Foreign Application Priority Data
Feb. 4, 2013 (JP) 2013-019654

(51) Int. Cl. H02P 27/06; H02P 7/06

(52) U.S. Cl. CPC H02P 27/06; H02P 7/06

(57) ABSTRACT

A solar energy utilization system includes a solar panel, a motor that is driven by solar output power, and a motor stall prevention device that prevents the motor during drive from stalling, and as the motor stall prevention device, any of following devices is selected: (a) a motor stall prevention device that limits solar output voltage to voltage higher than voltage at which the solar panel outputs maximum power at the point in time; (b) a motor stall prevention device that limits solar output voltage to voltage at which, when the output voltage is changed on a P-V curve, a change rate becomes negative; and (c) a motor stall prevention device that is configured by a capacitor which is connected in parallel to the solar panel and stores power generated by the solar panel.

### TECHNICAL FIELD

The present invention relates to a solar energy utilization system, and a cool box, an air conditioner or a pump included therein.

### BACKGROUND ART

Various systems that convert solar energy into power by a solar panel (solar cell) and drive equipment with the power have been proposed. Examples thereof can be found in PTLs 1 to 8.

PTL 1 describes an air conditioning device that uses a solar cell as a power source. In this air conditioning device, direct current power which is output by the solar cell is converted with a DC-DC converter into direct current power of voltage requested by a load. Then, the direct current power output by the DC-DC converter is converted with a variable voltage/variable frequency inverter into alternating current power of the voltage and a frequency according to the load, and a compressor is driven by the alternating current power output by the variable voltage/variable frequency inverter. The compressor is caused to operate at a maximum output point of the solar cell by MPPT (maximum power point tracking).

PTL 2 describes a refrigerator. A power source system of this refrigerator includes a solar cell, a storage cell which is charged with midnight power of a commercial power source, a bidirectional converter which is connected to the solar cell and the storage cell, an inverter circuit which drives a compressor, and a commercial power source system which is joint-connected to the bidirectional converter. Since the storage cell is charged with the power in a midnight charge time zone and used in addition to using power generated by the solar cell, it is possible to save power charge of the refrigerator. The refrigerator is driven by the solar cell in daytime by MPPT.

PTL 3 describes a power supply system. This power supply system supplies power to a load which is driven by direct current power, and includes a first power source unit (solar cell) which outputs and supplies direct current power to the load, and a second power source unit (commercial power source) which supplies power for a deficiency of the direct current power to be supplied to the load from the first power source unit. When an air conditioner is driven by the solar cell, it is performed by MPPT.

PTL 4 describes a control device of rotation equipment using a solar cell. This device controls a rotation speed of the rotation equipment by tracking or searching for a maximum power point where input power from the solar cell is maximum, that is, performs MPPT. In this device, the maximum power point is tracked or searched for by defining an increased or decreased value of an operating frequency based on the operating frequency of the rotation equipment.

PTL 5 describes a solar power generation system. This system includes a solar panel, an inverter which drives a load such as a pump by converting output direct current power of the solar panel into alternating current power, and a control device which controls the inverter. This system drives the load at a variable speed so as to follow a maximum power point of the solar panel, that is, performs MPPT.

PTL 6 describes a pump system being driven by a solar cell. This system converts power output of the solar cell from direct current to alternating current through an inverter and drives an induction motor. In this system, a PWM inverter is used for the inverter, an oscillation frequency of the inverter is defined through a delay element with respect to supply voltage of the induction motor, a ratio of output voltage and input voltage of the inverter is maintained within a range of a predetermined ratio with respect to the oscillation frequency.

PTL 7 describes a pumping device using a solar cell. In this device, a brushless motor is used as a motor for driving a pump, and this brushless motor is driven by a versatile inverter without having means for detecting a rotor magnetic position.

PTL 8 describes a solar cell driven refrigerant cycle device. Pseudo alternating current power the frequency of which can be controlled is generated by an inverter from power generated at a solar cell to operate an electric operation element with this pseudo alternating current power.

A configuration example of equipment which is driven by power output by a solar panel is shown in FIG. 24. The equipment of FIG. 24 is an air conditioner. Direct current power output by a solar panel 991 is converted by a DC-DC converter 992 into direct current of voltage requested by a compressor 996 of the air conditioner, and input to a VVVF (variable voltage, variable frequency) inverter 995 which performs VVVF control. The VVVF inverter 995 converts the direct current power into alternating current power of a frequency and voltage suitable for a number of revolutions of the compressor 996. The direct current power output by the DC-DC converter 992 is also used for driving a direct current motor 998 of an air blower which is arranged in indoor equipment of the air conditioner and a direct current motor 999 of an air blower which is arranged in an outdoor equipment thereof. A system control circuit 997 performs MPPT control, and efficiently causes the compressor 996 and the direct current motors 998 and 999 to operate by using a maximum power point of power generated by the solar panel 991.

### CITATION LIST

### Patent Literatures

PTL 1: Japanese Unexamined Patent Application Publication No. 6-117678

PTL 2: Japanese Unexamined Patent Application Publication No. 7-184331

PTL 3: Japanese Patent No. 3294630

PTL 4: Japanese Unexamined Patent Application Publication No. 2003-9572

PTL 5: Japanese Patent No. 3733481

PTL 6: Japanese Unexamined Patent Application Publication No. 60-249682

PTL 7: Japanese Unexamined Patent Application Publication No. 2004-153979

PTL 8: Japanese Unexamined Patent Application Publication No. 2005-226918

### SUMMARY OF INVENTION

### Technical Problem

When power output by a solar panel is used to drive a load including a motor, which is an inductive load, by MPPT control, there is a possibility that motor operation becomes unstable. That is, in a case where the motor is a synchronous motor, when torque which is equal to or more than torque output by the motor with maximum power output by the solar panel is required, synchronization is not maintained, so that the motor loses synchronization and results in stopping. Even if it is set so that the torque which is equal to or more than the torque output by the motor with maximum power output by the solar panel is not required, in cases where a cloud is over the sun, a person or an animal approaches the solar panel causing the solar panel to be shaded, etc., there is a possibility that output of the solar panel decreases rapidly and the motor has reduced torque and loses synchronization. Once the motor loses synchronization, a certain time of several minutes may be necessary for restoration, thus lowering operation availability of a device.

Even if the motor is an inductive motor or a direct current commutator motor, when being driven by MPPT control, it is not possible to eliminate a possibility of operation being unstable. When the torque which is equal to or more than the torque output by the motor with maximum power output by the solar panel is required, current flowing in the motor increases. Increase in the current means that an operation point moves to left in a P-V curve of the solar panel. When the operation point moves to a left side of a maximum power point, the motor has reduced torque and stalls.

The present invention has been made in view of the aforementioned points, and aims to provide a solar energy utilization system which drives a load including a motor by power output by a solar panel, in which it is possible to operate the motor stably while utilizing power effectively.

### Solution to Problem

A solar energy utilization system according to the present invention is configured as follows. That is, a solar panel; a motor that is driven by power output by the solar panel; and a motor stall prevention device that prevents the motor during drive from stalling are included, and as the motor stall prevention device, any of following devices is selected:

(a) a motor stall prevention device that limits output voltage of the solar panel to voltage higher than voltage at which the solar panel outputs maximum power at the point in time;

(b) a motor stall prevention device that limits the output voltage of the solar panel to voltage at which, when the output voltage is changed on a P-V curve, a change rate becomes negative; and

(c) a motor stall prevention device that is configured by a capacitor which is connected in parallel to the solar panel and stores power generated by the solar panel.

With this configuration, since the motor stall prevention device that prevents the motor from operating unstably and stalling is included, it is possible to operate the motor stably while utilizing power effectively.

By selecting the motor stall prevention device that performs control to limit the output voltage of the solar panel to voltage higher than the voltage at which the solar panel outputs the maximum power at the point in time as the motor stall prevention device, when a load of the motor increases, output power of the solar panel is enhanced, so that it is possible to prevent the motor during drive from stalling.

By selecting the motor stall prevention device that performs control to limit the output voltage of the solar panel to voltage at which, when the output voltage is changed on the P-V curve, the change rate becomes negative as the motor stall prevention device, when the load of the motor increases, the output power of the solar panel is enhanced, so that it is possible to prevent the motor during drive from stalling.

Further, the change rate of the output power of the solar panel decreases monotonically as being close to a maximum power point and becomes zero at the maximum power point. Therefore, by measuring this change rate, it is possible to easily estimate how far an operation point at a certain point is from the maximum power point without knowing a position of the maximum power point at all nor reaching the maximum power point. Accordingly, even when a model of the solar panel is changed to another one or performance of the solar panel changes with change due to temperature or lapse of time, it is possible to continue stall prevention of the motor without changing setting or the like particularly.

By selecting the motor stall prevention device that is configured by the capacitor which is connected in parallel to the solar panel and stores power generated by the solar panel is selected as the motor stall prevention device, the motor is able to utilize the power output by the solar panel efficiently, so that it is possible to prevent the motor during drive from stalling, even when the load of the motor increases.

The solar energy utilization system with the aforementioned configuration is preferably configured as follows. That is, as the motor stall prevention device, the motor stall prevention device that performs control to limit the output voltage of the solar panel to voltage higher than the voltage at which the solar panel outputs the maximum power at the point in time is selected, and the motor stall prevention device performs control so that output voltage V of the solar panel meets

V>Vm+Voff1

with respect to maximum power output voltage Vm at which the solar panel outputs the maximum power at the point in time and a predetermined positive offset voltage value Voff1.

With this configuration, since the motor stall prevention device performs control to limit the output voltage of the solar panel to voltage higher than the voltage at which the solar panel outputs the maximum power at the point in time, when the load of the motor increases, the output power of the solar panel is enhanced, so that it is possible to prevent the motor from stalling. Moreover, by performing control so that, with respect to maximum power output voltage Vm at which the solar panel outputs the maximum power at the point in time and the predetermined positive offset voltage value Voff1, the output voltage V of the solar panel meets

V>Vm+Voff1,

even when rapid output fluctuation is caused in the solar panel, it becomes possible to operate the motor stably.

The solar energy utilization system with the aforementioned configuration is preferably configured as follows. That is, the motor stall prevention device decreases a number of revolutions of the motor when a difference between the maximum power output voltage Vm and the output voltage V is the offset voltage value Voff1 or less, and increases the number of revolutions of the motor when the difference between the maximum power output voltage Vm and the output voltage V is a predetermined positive offset voltage value Voff2 (>Voff1) or more.

With this configuration, since it is possible to keep the operation point of the solar panel near the maximum power point while stabilizing the operation of the motor, it is possible to utilize the power output by the solar panel effectively. Moreover, since such control is able to be performed only by measuring the output voltage of the solar panel, it is possible to simplify a control circuit.

The solar energy utilization system with the aforementioned configuration is preferably configured as follows. That is, the offset voltage value Voff1 meets 0.18×Vm≧Voff1>0.05×Vm.

With this configuration, it is possible to sufficiently achieve an effect that the motor is driven stably against rapid output fluctuation of the solar panel. Moreover, an effect is achieved that the power output by the solar panel is able to be utilized sufficiently effectively.

The solar energy utilization system with the aforementioned configuration is preferably configured as follows. That is, the offset voltage value Voff2 meets Voff2≧Voff1+0.02×Vm and Voff2≦0.2×Vm.

With this configuration, it is possible to achieve an effect that the number of revolutions of the motor does not need to be changed excessively frequently. Moreover, an effect is achieved that the power output by the solar panel is able to be utilized sufficiently effectively.

The solar energy utilization system with the aforementioned configuration is preferably configured as follows. That is, a thermometer that measures temperature of the solar panel is included, and a control circuit of the motor stall prevention device performs motor stall prevention control by correcting the maximum output voltage Vm according to the temperature measured by the thermometer.

With this configuration, it becomes possible to grasp the output voltage Vm at the maximum power point more correctly, and to utilize the power output by the solar panel efficiently while reliably preventing the motor from operating unstably and stalling.

The solar energy utilization system with the aforementioned configuration is preferably configured as follows. That is, as the motor stall prevention device, the motor stall prevention device that performs control to limit the output voltage of the solar panel to voltage higher than the voltage at which the solar panel outputs the maximum power at the point in time is selected, and the motor stall prevention device performs control so that output power P of the solar panel that is obtained by estimation or by actual measurement of a number of revolutions of the motor meets

P<Pm−Poff1

with respect to maximum output power Pm of the solar panel at the point in time, which is estimated by using the number of revolutions of the motor and the output power of the solar panel, and a predetermined positive offset power value Poff1.

With this configuration, even when rapid output fluctuation is caused in the solar panel, it becomes possible to operate the motor stably.

The solar energy utilization system with the aforementioned configuration is preferably configured as follows. That is, the motor stall prevention device decreases the number of revolutions of the motor when a difference between the maximum output power Pm and the output power P is the offset power value Poff1 or less, and increases the number of revolutions of the motor when the difference between the maximum output power Pm and the output power P is a predetermined power value Poff2 or more.

With this configuration, since it is possible to keep the operation point of the solar panel near the maximum power point while stabilizing the operation of the motor, it is possible to utilize the power output by the solar panel effectively.

The solar energy utilization system with the aforementioned configuration is preferably configured as follows. That is, the offset power value Poff1 meets 0.4 Pm≧Poff1≧0.03×Pm.

With this configuration, it is possible to sufficiently achieve an effect that the motor is driven stably against rapid output fluctuation of the solar panel. Moreover, an effect is achieved that the power output by the solar panel is able to be utilized sufficiently effectively.

The solar energy utilization system with the aforementioned configuration is preferably configured as follows. That is, the offset power value Poff2 meets Poff2≧Poff1+0.02×Pm and Poff≦0.5 Pm.

With this configuration, it is possible to achieve an effect that the number of revolutions of the motor does not need to be changed excessively frequently. Moreover, an effect is achieved that the power output by the solar panel is able to be utilized sufficiently effectively.

The solar energy utilization system with the aforementioned configuration is preferably configured as follows. That is, a thermometer that measures temperature of the solar panel is included, and a control circuit of the motor stall prevention device performs motor stall prevention control by correcting the maximum output power Pm according to the temperature measured by the thermometer.

With this configuration, it becomes possible to grasp the output power Pm at the maximum power point more correctly, and to utilize the power output by the solar panel efficiently while reliably preventing the motor from operating unstably and stalling.

The solar energy utilization system with the aforementioned configuration is preferably configured as follows. That is, as the motor stall prevention device, the motor stall prevention device that performs control to limit the output voltage of the solar panel to voltage at which, when the output voltage is changed on the P-V curve, the change rate becomes negative is selected, and the motor stall prevention device obtains a change rate ΔP/ΔV of output power of the solar panel from change in the output voltage ΔV of the solar panel and change in the output power ΔP of the solar panel when power consumption of the motor is changed, and performs control so that, with respect to a predetermined positive change rate s1, an absolute value of the change rate ΔP/ΔV meets

|ΔP/ΔV|>s1.

With this configuration, even when rapid output fluctuation is caused in the solar panel, it becomes possible to operate the motor stably.

The solar energy utilization system with the aforementioned configuration is preferably configured as follows. That is, the motor stall prevention device decreases a number of revolutions of the motor when the absolute value of the change rate ΔP/ΔV is the change rate s1 or less, and increases the number of revolutions of the motor when the absolute value of the change rate ΔP/ΔV is a predetermined positive change rate s2 or more, which is larger than the change rate s1.

With this configuration, it is possible to operate the motor stably while utilizing power generation capability of the solar panel effectively with a power generation amount of the solar panel maintained at a high level.

The solar energy utilization system with the aforementioned configuration is preferably configured as follows. That is, the change rate s1 meets 1.0≦s1×(Vm/Pm)≦5.7 (where Vm and Pm are maximum power output voltage and maximum power of the solar panel at the point in time, respectively).

With this configuration, it is possible to sufficiently achieve an effect that the motor is driven stably against rapid output fluctuation of the solar panel. Moreover, an effect is achieved that the power output by the solar panel is able to be utilized sufficiently effectively.

The solar energy utilization system with the aforementioned configuration is preferably configured as follows. That is, the change rate s2 meets s2×(Vm/Pm)≧s1×(Vm/Pm)+0.4 and s2×(Vm/Pm)≦6.7 (where Vm and Pm are maximum power output voltage and maximum power of the solar panel at the point in time, respectively).

With this configuration, it is possible to achieve an effect that the number of revolutions of the motor does not need to be changed excessively frequently. Moreover, an effect is achieved that the power output by the solar panel is able to be utilized sufficiently effectively.

The solar energy utilization system with the aforementioned configuration is preferably configured as follows. That is, ΔP when the change rate ΔP/ΔV is obtained is set as a negative value.

With this configuration, since the operation point becomes far from the maximum power point when the change rate ΔP/ΔV of the output power of the solar panel is obtained, it is possible to prevent the operation of the motor from becoming unstable.

The solar energy utilization system with the aforementioned configuration is preferably configured as follows. That is, the motor is an inverter control motor, and the motor stall prevention device is configured by an inverter and a control circuit of the inverter.

With this configuration, the motor stall prevention device is able to be configured easily.

The solar energy utilization system with the aforementioned configuration is preferably configured as follows. That is, the motor is a direct current commutator motor, and the motor stall prevention device is configured by a DC-DC converter and a control circuit of the DC-DC converter.

With this configuration, the motor stall prevention device is able to be configured easily.

The solar energy utilization system with the aforementioned configuration is preferably configured as follows. That is, as the motor stall prevention device, the motor stall prevention device that is configured by the capacitor which is connected in parallel to the solar panel and stores power generated by the solar panel is selected, and a capacity C of the capacitor is 22.2 mF or more and 100 F or less.

With this configuration, it is possible to exert an effect of the motor stall prevention sufficiently.

Moreover, the present invention is a cool box, an air conditioner or a pump included in the solar energy utilization system with the aforementioned configuration by including the motor and the motor stall prevention device.

With this configuration, it is possible to provide a cool box, an air conditioner or a pump capable of utilizing the power generated by the solar panel effectively. Moreover, stable operation is possible even in the case of driving only with the power generated by the solar panel.

In a cool box that drives a compressor by the motor which operates with the power output by the solar panel, a control circuit preferably increases or decreases the number of revolutions of the motor according to increase or decrease in sunlight intensity radiated to the solar panel.

With this configuration, it is possible to drive the compressor of the cool box even in morning and evening time zones where the sunlight intensity is weak. Further, in a daytime time zone where the sunlight intensity is strong, it is possible to perform cooling powerfully by increasing the number of revolutions of the motor, thus making it possible to utilize much more solar energy.

In the cool box with the aforementioned configuration, it is preferable that maximum output power PS of the solar panel and maximum power consumption PM of the motor satisfy a relation of

0.5≦PS/PM≦1.5.

With this configuration, since the motor is able to utilize the power output by the solar panel efficiently, it is possible to suppress device costs by reducing a size of the solar panel. Moreover, it is possible to sufficiently perform, in daytime, cool storage operation needed for cooling in night time.

In the cool box with the aforementioned configuration, it is preferable that the motor is able to be driven also by a commercial power source.

With this configuration, it is possible to operate the cool box as a stand-alone system in a region where there is no commercial power source. Moreover, in a region where there is a commercial power source, it is possible to selectively use either the solar panel or the commercial power source in consideration of various factors including costs, convenience, and stability.

In the cool box with the aforementioned configuration, it is preferable that a cool storage agent is arranged in the box.

With this configuration, it becomes possible to keep a box inside at predetermined temperature or less reliably even in night time during which the solar panel is not able to generate power. Alternatively, even when it was not possible to output power sufficiently because of weather, for example, due to rainy weather, it is possible to keep the box inside at the predetermined temperature or less until weather which allows sufficient power generation is recovered.

### Advantageous Effects of Invention

According to the present invention, a solar panel, a motor that is driven by power output by the solar panel, and a motor stall prevention device that prevents the motor during drive from stalling are included, and as the motor stall prevention device, any of: a motor stall prevention device that performs control for limiting output voltage of the solar panel to voltage higher than voltage at which the solar panel outputs maximum power at the point in time; a motor stall prevention device that performs control for limiting output voltage of the solar panel to voltage at which, when the output voltage is changed on a P-V curve, a change rate becomes negative; or a motor stall prevention device that is configured by a capacitor which is connected in parallel to the solar panel and stores power generated by the solar panel is selected, thus making it possible to operate the motor stably while utilizing power effectively.

### BRIEF DESCRIPTION OF DRAWINGS

FIG. 1 is a schematic configuration view of a solar energy utilization system according to a first embodiment of the present invention;

FIG. 2 is a first P-V diagram describing the present invention;

FIG. 3 is a second P-V diagram describing the present invention;

FIG. 4 is a first graph showing how maximum power output by a solar panel and power used therefrom shift in a day;

FIG. 5 is a second graph showing how maximum power output by the solar panel and power used therefrom shift in a day;

FIG. 6 is a third graph showing how maximum power output by the solar panel and power used therefrom shift in a day;

FIG. 7 is a fourth graph showing how maximum power output by the solar panel and power used therefrom shift in a day;

FIG. 8 is a graph showing a relation of power output by the solar panel and power usage;

FIG. 9 is a first flowchart describing operation of the solar energy utilization system;

FIG. 10 is a third P-V diagram describing the present invention;

FIG. 11 is a fourth P-V diagram describing the present invention;

FIG. 12 is a second flowchart describing operation of the solar energy utilization system;

FIG. 13 is a fifth P-V diagram describing the present invention;

FIG. 14 is a first graph showing a relation of output power of the solar panel and a number of revolutions of a motor;

FIG. 15 is a sixth P-V diagram describing the present invention;

FIG. 16 is a schematic configuration view of a solar energy utilization system according to a second embodiment of the present invention;

FIG. 17 is a seventh P-V diagram describing the present invention;

FIG. 18 is a third flowchart describing operation of the solar energy utilization system;

FIG. 19 is a second graph showing a relation of output power of the solar panel and a number of revolutions of a motor;

FIG. 20 is an eighth P-V diagram describing the present invention;

FIG. 21 is a schematic configuration view of a solar energy utilization system according to a third embodiment of the present invention;

FIG. 22 is a schematic configuration view of a solar energy utilization system according to a fourth embodiment of the present invention;

FIG. 23 is a schematic configuration view of a solar energy utilization system according to a fifth embodiment of the present invention; and

FIG. 24 is a schematic configuration view of a conventional solar energy utilization system.

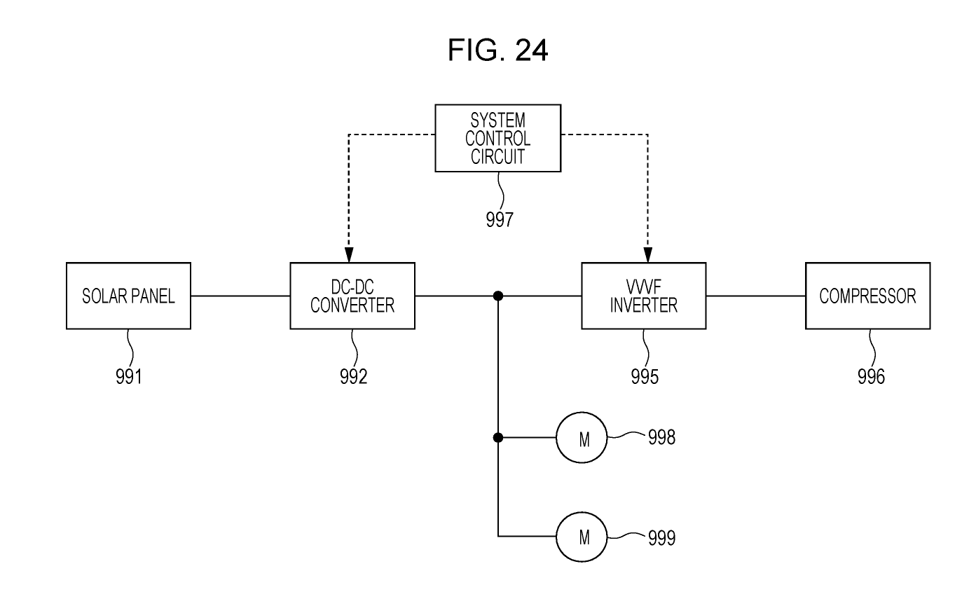

### DESCRIPTION OF EMBODIMENTS

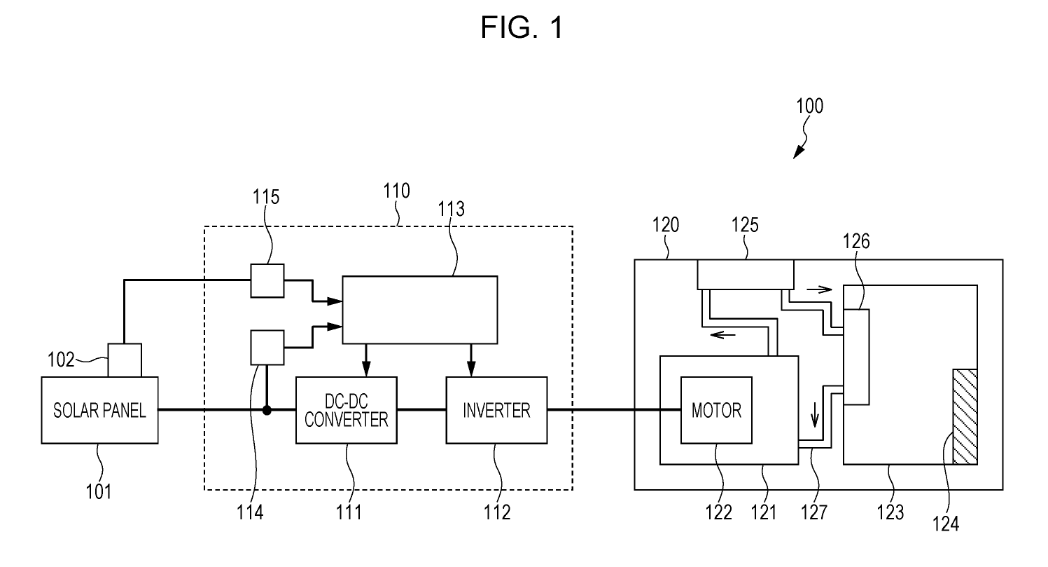

Description will hereinafter be given for embodiments of a first embodiment to a fifth embodiment based on figures from FIG. 1 to FIG. 23.

### First Embodiment

A solar energy utilization system 100 shown in FIG. 1 is configured by a solar panel 101, a control unit 110, and equipment serving as a load. Though various equipment such as a cool box, an air conditioner or a pump may be the load, a cool box 120 is selected as the load here. Direct current power output by the solar panel 101 is sent to the control unit 110, and power for driving the cool box 120 is output from the control unit 110 to the cool box 120. Note that, the direct current power output by the solar panel 101 is referred to as “solar output power” in this description in some cases.

As a solar cell which configures the solar panel 101, in addition to silicon-based solar cells such as a monocrystalline silicon solar cell, a polycrystalline silicon solar cell and an amorphous silicon solar cell, compound-based solar cells such as a GaAs solar cell, an InGaAs solar cell, a CdTe—CdS-based solar cell, a chalcopyrite-based solar cell, a dye-sensitized solar cell, and an organic thin-film solar cell are usable. At present, a thin-film silicon solar cell of a polycrystalline type or an amorphous type is preferably used in terms of cost. The solar panel 101 is not limited to one in a flat plate shape which is enclosed by a glass or the like. One in a film shape which is able to be bent is also allowed.

In the control unit 110, a DC-DC converter 111, an inverter 112, a control circuit unit 113, a voltage sensor circuit 114 and a temperature sensor circuit 115 are arranged.

The DC-DC converter 111 steps up or steps down solar output power into a predetermined voltage value based on an instruction from the control circuit unit 113. When rated voltage of the solar output power is, for example, 35 V, the DC-DC converter 111 is able to perform stepping up, for example, to 380 V.

A circuit method of the DC-DC converter 111 is able to be set as a choke converter, a forward converter, a flyback converter, a half bridge converter, a full bridge converter, or the like. When the solar output power is around 200 W, it is preferable to use the forward converter which has a relatively high conversion efficiency in a power region thereof and is relatively non-expensive.

The inverter 112 converts the direct current power output by the DC-DC converter 111 into alternating current power with a voltage value needed by the cool box 120 based on an instruction from the control circuit unit 113.

The inverter 112 is able to be set as a two-level or three-level inverter by PWM (pulse width modulation) method. Moreover, VVVF (variable voltage, variable frequency) control is also able to be set. Voltage and a frequency of the alternating current power output by the inverter 112 are determined in accordance with a motor (described below) which drives a compressor mounted in the cool box 120.

The voltage sensor circuit 114 converts the voltage value of the solar output power into a signal to transmit to the control circuit unit 113. The temperature sensor circuit 115 receives an output signal of a temperature sensor 102 which is arranged inside the solar panel 101 or at a site adjacent to the solar panel 101, and calculates temperature of the solar panel 101 to transmit to the control circuit unit 113.

The power which is converted into alternating current by the inverter 112 is output to the cool box 120. The cool box 120 may be a refrigerator, may be a freezer, or may be a refrigerator-freezer. The cool box 120 includes a compressor 121 which is driven by a motor 122, a cool chamber 123, a cool storage agent 124 which is arranged in the cool chamber 123, a condenser 125 which receives a refrigerant with high temperature and high pressure which is discharged from the compressor 121, a cooler 126 which evaporates, inside thereof, the refrigerant which has performed heat radiation in the condenser 125 to thereby obtain cold heat and cool the cool chamber 123, and a refrigerant piping 127 which circulates the refrigerant from the compressor 121 to the condenser 125, from the condenser 125 to the cooler 126, and from the cooler 126 again to the compressor 121. Note that, though not shown, an expansion valve is arranged between the condenser 125 and the cooler 126. The cool storage agent 124 which is arranged in the cool chamber 123 functions to keep temperature of the cool chamber 123 at low temperature even in night time during which the solar output power is not supplied.

The solar output power is determined according to power consumption of the cool box 120 which serves as the load. A preferable aspect of the cool box 120 is that the cool chamber 123 is kept at low temperature even in night time during which the solar panel 101 does not generate power. A more preferable aspect is that the cool chamber 123 is kept at low temperature even when there is a case where the solar panel 101 has not generated any power for a whole day because of rainy weather. In order to realize the aforementioned “more preferable aspect”, when a sunlight time for a day is 10 hours, the cool chamber 123 needs to be kept at low temperature for 38 hours in a state without power generation of the solar panel 101.

A configuration example which is able to realize the aforementioned “more preferable aspect” is as follows. An installation place of the solar energy utilization system is set at a spot where a latitude is 12 degrees and outside air temperature is 30° C. A solar panel having rated maximum output of 235 W is used. A capacity of the cool chamber is set as 200 litters, and as the cool storage agent to be installed in the cool chamber, one which has latent heat of fusion of 230 kJ/kg is arranged by 16.5 kg of weight.

The motor 122 which drives the compressor 121 is an alternating current induction motor or an alternating current synchronous motor which is an inverter control motor. The motor 122 operates with a number of revolutions and torque according to an output frequency and output voltage of alternating current power output by the inverter 112. As the motor 122, for example, one which has a minimum number of revolutions of 1500 rpm, a maximum number of revolutions of 5000 rpm, a maximum power consumption of 150 W and operation voltage of 220 V is usable.

As the load of the inverter 112, in addition to the motor 122, a light load such as a temperature control device (not shown) in the cool box 120 or a display device (not shown) provided in the cool box 120 may be connected. The load other than the motor 122 may be connected to an output unit of the DC-DC converter 111 or an output unit of the solar panel 101.

The control circuit unit 113 estimates an operation point of the solar panel 101 at present based on the output voltage of the solar panel 101 transmitted from the voltage sensor circuit 114. The control circuit unit 113 further corrects the operation point of the solar panel 101 based on temperature of the solar panel 101 transmitted from the temperature sensor circuit 115. After grasping the operation point of the solar panel 101, the control circuit unit 113 controls the DC-DC converter 111 and the inverter 112. Note that, in this description, the output voltage of the solar panel 101 is referred to as “solar output voltage” in some cases.

The control circuit unit 113 performs operation start and operation stop of the DC-DC converter 111 and the inverter 112, changing of a step up (step down) ratio of the DC-DC converter 111, and changing of the output voltage and the frequency of the inverter 112. Through such control, the control circuit unit 113 drives the motor 122 to rotate at a speed as high as possible and stably according to the solar output power.

Between the solar panel 101 and the DC-DC converter 111, output of an AC adapter (not shown) which is connected to a commercial power source is able to be connected.

Specifically, when the rated output voltage of the solar panel 101 is 35 V, the AC adapter which outputs DC 30 V is able to be connected. This makes it possible to prevent the motor 122 from losing synchronization and stopping even when the solar panel 101 causes significantly great reduction of output.

### (Motor Stall Prevention Device of First Embodiment)

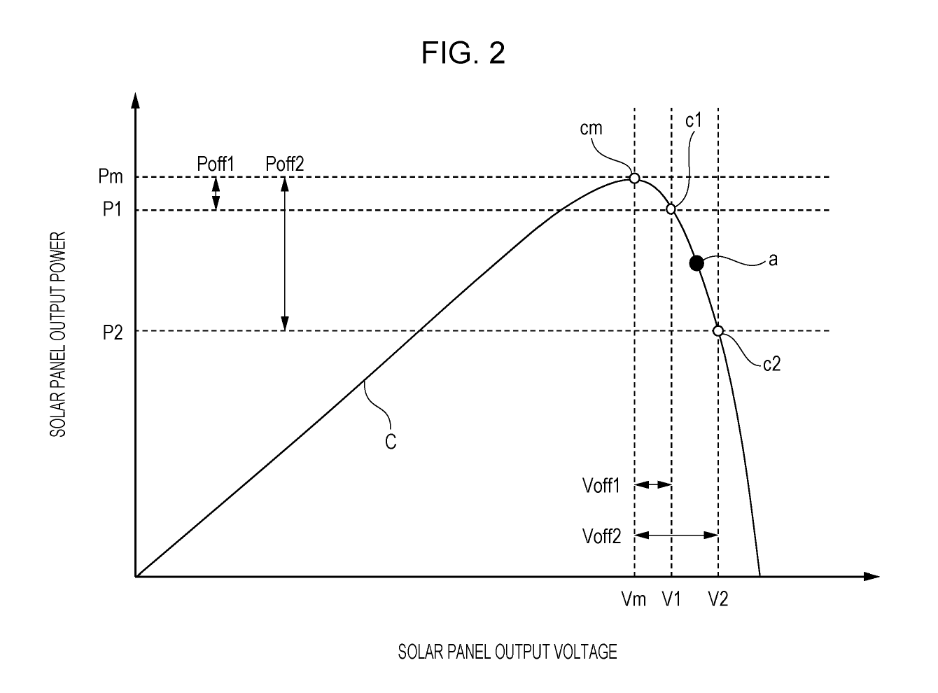

The solar energy utilization system 100 includes a motor stall prevention device which prevents the motor 122 during drive from stalling. Basic operation principles of the motor stall prevention device in the first embodiment will be described with FIG. 2.

In a graph of FIG. 2, output performance of a general solar panel is drawn as a P-V curve (curve obtained by plotting a relation between output power and output voltage). The solar output voltage becomes maximum during open (during no load), decreases as the load increases and the output power increases, and becomes zero during short-circuiting.

On the other hand, the solar output power becomes maximum when the output voltage is about 80% of the voltage during open. The operation point at this time is called a maximum power point. In FIG. 2, the output voltage and the output power at the maximum power point cm in the P-V curve C are set as Vm and Pm, respectively.

The motor stall prevention device in the first embodiment is configured by the inverter 112 and the control circuit unit 113 which controls the inverter 112. The motor stall prevention device limits the output voltage of the solar panel 101 to voltage higher than the voltage Vm at which the solar panel 101 outputs the maximum power Pm at the point in time. That is, the motor stall prevention device causes the output voltage of the solar panel 101 not to be used as the voltage which is not more than the voltage Vm. It is delineated such that an operation point a of the solar panel 101 is maintained on a right side of the maximum power point cm so as not to be overlapped with the maximum power point cm in the P-V curve C of FIG. 2.

When the load is put on the motor 122 which is an inductive load, current flowing in the motor 122 increases to cause torque. When the operation point a exists on the right side of the maximum power point cm, if the load is put on the motor 122, the operation point a moves to a left side spontaneously on the P-V curve C. Thereby, the solar output voltage decreases, but the output current increases, so that the output power which is the product of them increases. As a result thereof, the motor 122 operates stably.

When the operation point a exists on the left side of the maximum power point cm as well, if the load is put on the motor 122, the operation point a moves to the left side spontaneously on the P-V curve C. In this case, however, even though the output current hardly increases, the output voltage is lowered, so that the output power decreases. As a result thereof, the motor 122 has reduced torque, loses synchronization, and stops.

As is clear from the above, when the load including the motor is connected to the solar panel, if trying to operate at the maximum power point of the solar panel, the operation point moves to the left side of the maximum power point easily. As a result thereof, there is a possibility that the motor operates unstably, loses synchronization, and stops.

In order to limit the output voltage of the solar panel 101 to voltage higher than the voltage Vm at which the solar panel 101 outputs the maximum power Pm at the point in time, first, the maximum power point needs to be known. As a method for searching for the maximum power point, conventionally, a “hill climbing method” is commonly used. The “hill climbing method” is a method for searching for the maximum power point by increasing voltage little by little. In order to carry out the “hill climbing method”, it is necessary to inevitably enter the left side of the maximum power point in the P-V curve. Therefore, when trying to perform control of MPPT by searching for the maximum power point with the “hill climbing method”, it has been impossible to avoid such inconvenience that there is a possibility that the motor operates unstably, loses synchronization, and stops.

Against this, since the motor stall prevention device in the first embodiment limits the solar output voltage to voltage higher than the voltage Vm at which the solar panel 101 outputs the maximum power Pm at the point in time as described above, it is possible to avoid becoming unstable of the operation of the motor 122, which is inevitable when the solar output voltage is the voltage Vm or less. Accordingly, the solar energy utilization system 100 becomes possible to operate the motor 122 stably while utilizing power generation capability of the solar panel 101 effectively.

It is more preferable that the motor stall prevention device in the first embodiment performs control so that, with respect to the maximum power output voltage Vm at which the solar panel 101 outputs the maximum power at the point in time and a predetermined positive offset voltage value Voff1, the solar output voltage V meets

V>Vm+Voff1.

That is, it is more preferable that the control is performed so that the operation point a exists on the right side of a point c1 corresponding to voltage V1 which is higher than the maximum power output voltage Vm by the offset voltage value Voff1 on the P-V curve C of FIG. 2.

In this manner, by setting the predetermined positive offset voltage value Voff1 and controlling the solar output voltage V to meet V>Vm+Voff1, even when rapid output fluctuation is caused in the solar panel 101, it becomes possible to drive the motor 122 serving as the load stably.

In addition to the predetermined positive offset voltage value Voff1, a predetermined positive offset voltage value Voff2 and predetermined positive offset power values Poff1 and Poff2 are set. Here, the offset voltage values Voff1 and Voff2 and the offset power values Poff1 and Poff2 were determined based on a table 1. The table 1 shows performances of a general silicon-based solar cell, and the maximum power points (Pm, Vm) serve as references.

TABLE 1

| | | | | | | | | |
|---|---|---|---|---|---|---|---|---|
| P | Pm | 0.97 Pm | 0.95 Pm | 0.9 Pm | 0.8 Pm | 0.7 Pm | 0.6 Pm | 0.5 Pm |
| V | Vm | 1.05 Vm | 1.07 Vm | 1.1 Vm | 1.13 Vm | 1.15 Vm | 1.18 Vm | 1.2 Vm |

The offset voltage value Voff1 preferably meets 0.18×Vm≧Voff1≧0.05×Vm. Under the condition above, when a representative silicon-based solar cell is used as the solar cell, the output power of the solar panel becomes 60% to 97% of the maximum power in the case of V=Vm+Voff1. When the offset voltage value Voff1 meets Voff1≧0.05×Vm, an effect is sufficiently achieved that the motor 122 is driven stably against rapid output fluctuation of the solar panel 101. Moreover, when 0.18×Vm≧Voff1 is met, an effect is achieved that the power output by the solar panel 101 is able to be utilized sufficiently effectively.

As shown in FIG. 2, it is further preferable that the positive offset voltage value Voff2 which is larger than Voff1 is set and control is performed so that, with respect to the maximum power output voltage Vm at which the solar panel 101 outputs the maximum power at the point in time and the predetermined positive offset voltage values Voff1 and Voff2, the solar output voltage V meets

Vm+Voff2>V>Vm+Voff1.

That is, the operation point a is limited to be between a point c1 and a point c2, and the solar output voltage V is limited to be between the voltage V1 and the voltage V2.

The offset voltage value Voff2 preferably meets Voff2 Voff1+0.02×Vm and Voff2≦0.2×Vm. When the offset voltage value meets Voff2≧Voff1+0.02×Vm, an effect is achieved that the number of revolutions of the motor 122 does not need to be changed excessively frequently. Moreover, when Voff2≦0.2×Vm is met, an effect is achieved that the power output by the solar panel 101 is able to be utilized sufficiently effectively.

The preferable controlling method of the motor stall prevention device described above is able to be restated as follows. The solar output power at the point c1 is set as P1 and Poff1 is set as the positive offset power value. At this time, control is performed so that the solar output voltage V is limited to voltage higher than the maximum power output voltage Vm at which the solar panel 101 outputs the maximum power Pm at the point in time, and the solar output power P meets

P<Pm−Poff1.

Note that, since Pm−Poff1 is P1, the above formula is able to be rewritten as

P<P1.

The offset power value Poff1 preferably meets 0.4 Pm≧Poff1≧0.03×Pm. Under the condition above, when a representative silicon-based solar cell is used as the solar cell, the output voltage of the solar panel is from 1.18 Vm to 1.05 Vm in the case of P=Pm+Poff1. When the offset power value Poff1 meets Poff1≧0.03×Pm, an effect is sufficiently achieved that the motor 122 is driven stably against rapid output fluctuation of the solar panel 101. Moreover, when 0.4 Pm≧Poff1 is met, an effect is achieved that the power output by the solar panel 101 is able to be utilized sufficiently effectively.

Alternatively, the solar output power at the point c2 is set as P2 and Poff2 is set as a positive offset power value larger than Poff1. At this time, control is performed so that the solar output voltage V is limited to voltage higher than the voltage Vm at which the solar panel 101 outputs the maximum power, and the solar output power P meets

Pm−Poff2<P<Pm−Poff1.

Note that, since Pm−Poff2 is P2, the above formula is able to be rewritten as

P2<P<P1.

By limiting the operation point a to be between the point c1 and the point c2, it is possible to operate the motor 122 stably while utilizing power generation capability of the solar panel 101 more effectively with a power generation amount of the solar panel 101 maintained at a high level.

By limiting the operation point a to be between the point c1 and the point c2, it is possible to operate the motor 122 stably while utilizing power generation capability of the solar panel 101 more effectively with a power generation amount of the solar panel 101 maintained at a high level.

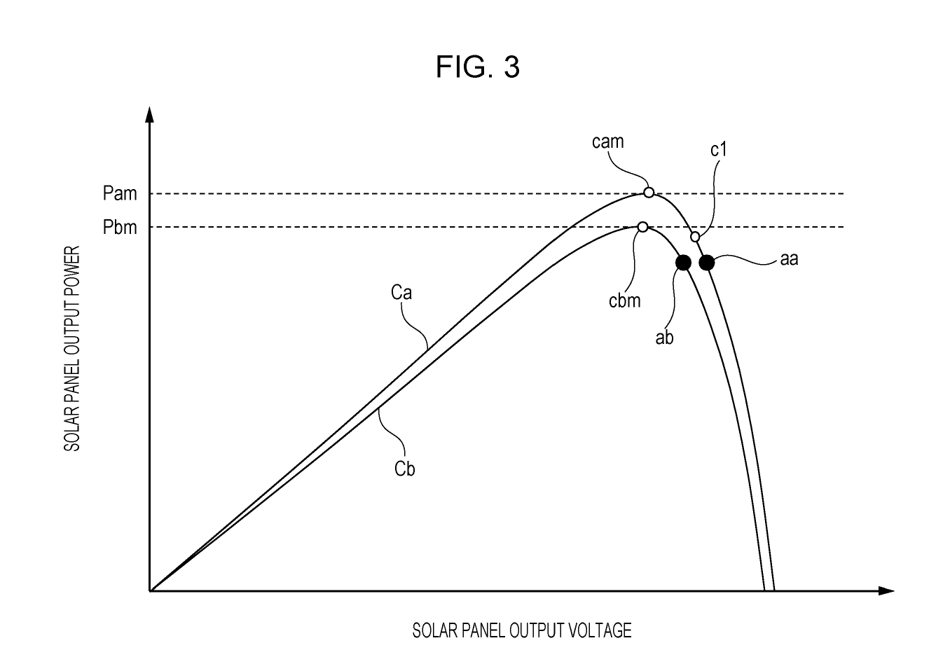

An advantage when the preferable controlling method of the motor stall prevention device as described above is carried out will be described by using FIG. 3. A P-V curve Ca drawn in FIG. 3 shows output performance of the solar panel 101 at a certain point. In the same manner, a P-V curve Cb drawn in FIG. 3 shows output performance when output of the solar panel 101 is rapidly reduced because a cloud is over the sun, a part of the solar panel 101 becomes shaded, etc. The maximum output power in the P-V curves Ca and Cb is Pam and Pbm, respectively.

When the output power at an operation point aa on the P-V curve Ca is Pbm or more, reduction of the power for driving the motor 122 due to output fluctuation of the solar panel 101 is inevitable and there is a possibility that the motor 122 operates unstably, loses synchronization, and stops. However, as shown in FIG. 3, when the output power at the operation point aa which is positioned on the right side of the point c1 is smaller than the maximum output power Pbm of the P-V curve Cb, the operation point aa on the P-V curve Ca moves to an operation point ab on the P-V curve Cb so that stable operation of the motor 122 is maintained.

In this manner, by performing control so that the solar output voltage V is limited to voltage higher than the maximum power output voltage Vm at which the solar panel 101 outputs the maximum power at the point in time and that, with the predetermined positive offset power value Poff1 set, the solar output power P meets P<Pm−Poff1, it becomes possible to drive the motor 122 serving as the load stably even when rapid output fluctuation is caused in the solar panel 101.

The offset power value Poff1 preferably meets 0.4 Pm≧Poff1≧0.03×Pm. When the offset power value Poff1 meets 0.4 Pm≧Poff1≧0.03×Pm, an effect is sufficiently achieved that the motor 122 is driven stably against rapid output fluctuation of the solar panel 101. Moreover, when 0.4 Pm≧Poff1 is met, an effect is achieved that the power output by the solar panel 101 is able to be utilized sufficiently effectively.

Here, description will be given for a way of determining the maximum power output voltage Vm and the maximum output power Pm at the maximum power point cm.

Conventionally, the maximum power point cm has been searched for actually by a method such as the hill climbing method to actually measure the maximum power output voltage Vm and the maximum output power Pm. However, this method is not appropriate because of causing a possibility that the motor 122 operates unstably, loses synchronization, and stops at a stage where the maximum power point cm is searched for or a stage where the maximum power point cm is reached.

In order to determine the maximum power output voltage Vm, performance of the solar panel 101 may be grasped in advance to define the maximum power output voltage Vm. Note that, when determining the maximum power output voltage Vm, correction by sunlight intensity is preferably performed. The correction by the sunlight intensity is able to be performed with a method of adding a sunlight recorder, estimating the sunlight intensity from output voltage and output power at a certain point, etc.

In the meantime, since the maximum power output voltage Vm of the solar panel 101 changes depending on temperature, the maximum power output voltage Vm is preferably corrected depending on temperature of the solar panel 101 measured by the temperature sensor 102 and the temperature sensor circuit 115. This makes it possible to grasp the maximum power output voltage Vm at the maximum power point cm more correctly, and to utilize the power output by the solar panel 101 more efficiently while more reliably preventing the motor 122 from operating unstably and losing synchronization.

The aforementioned correction of the maximum power output voltage Vm is able to be performed as follows. For example, when the solar panel 101 is a general silicon crystal-based solar cell, if temperature rises by 1° C., the output voltage is reduced by about 0.35%. Accordingly, if the maximum power output voltage Vm of the solar panel 101 is 30 V, when temperature rises by 10° C., the voltage is reduced by 3.5%, that is, reduced by 1.05 V, thus making it possible to set the maximum power output voltage Vm as 28.95 V.

Since the maximum output power Pm changes according to the sunlight intensity, estimation as follows is needed to determine the maximum output power Pm. That is, by measuring the number of revolutions of the motor 122 and the solar output voltage V at a certain point, it is possible to estimate a P-V curve at this point. From the estimated P-V curve, the maximum output power Pm is able to be estimated. This method will be described specifically later.

(Change in Number of Revolutions of Motor During Time from Sunrise to Sunset)

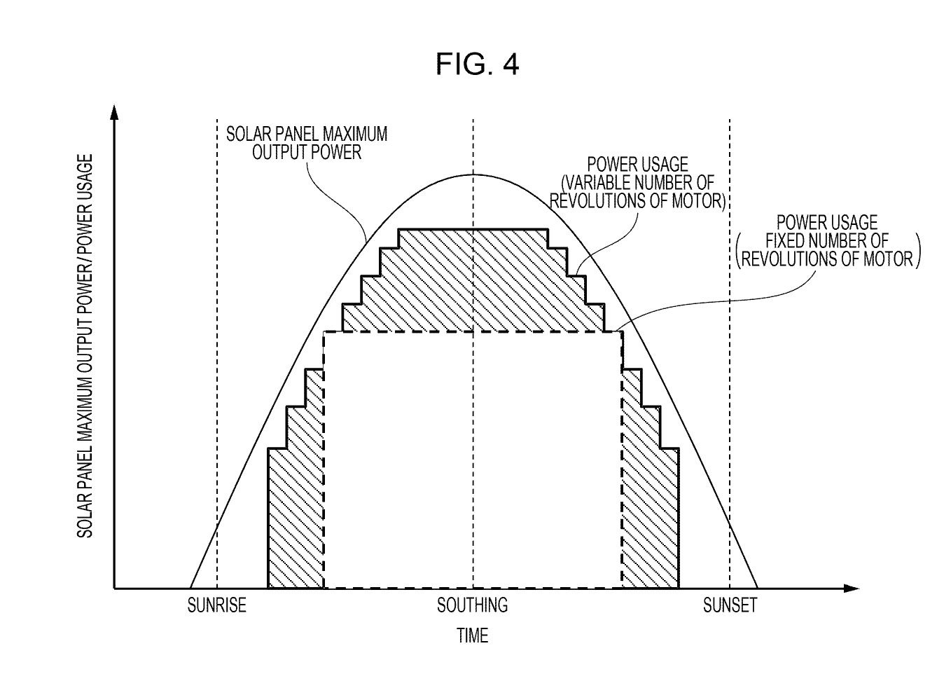

FIG. 4 shows how power consumption of the motor 122 of the solar energy utilization system 100 changes during time from sunrise to sunset. When change in motor power consumption due to change in an environment or a heat load is ignored, the change in the motor power consumption in FIG. 4 also represents change in the number of revolutions of the motor 122.

Conventionally, in a cool box which uses a solar panel as a power source, a number of revolutions of a motor of a compressor has been fixed. That is, when output of the solar panel becomes a fixed value or more after a while after sunrise, the compressor of the cool box starts to operate. The number of revolutions of the motor of the compressor has been fixed until the motor stops due to reduction in the output of the solar panel before sunset. Since the number of revolutions of the motor is fixed, as shown in FIG. 4, power usage of the load is also fixed.

On the other hand, in the cool box 120, the motor 122 of the compressor 121 is supplied with a part or all of needed power from the solar panel 101 to operate. According to increase or decrease in the sunlight intensity radiated to the solar panel 101, the number of revolutions of the motor 122 also increases or decreases. As shown in FIG. 4, the motor 122 starts low-speed rotation after a little time has lapsed after sunrise, and increases the number of revolutions in a stepwise manner as the sunlight intensity increases. Before and after a southing time point of the sun, the number of revolutions of the motor 122 becomes fixed and the power consumption of the motor 122 also becomes fixed, and this is because the number of revolutions of the motor 122 reaches the maximum number of revolutions. Thereafter, as the sunlight intensity decreases, the number of revolutions of the motor 122 is reduced in a stepwise manner, and when the sunlight intensity falls to such a level that even the minimum number of revolutions of the motor 122 is not able to be maintained, the motor 122 stops.

In this manner, when comparing the conventional cool box and the cool box 120, though using a solar panel as a power source in the same manner, it is found that the cool box 120 uses more power by a quantity indicated by a hatched-line part in FIG. 4. That is, by increasing or decreasing the number of revolutions of the motor 122 according to increase or decrease in the sunlight intensity radiated to the solar panel 101, it is possible to operate the compressor 121 even in morning and evening time zones where the sunlight intensity is weak. Further, in a daytime time zone where the sunlight intensity is strong, it is possible to operate the compressor 121 powerfully by increasing the number of revolutions of the motor 122. Thereby, it is possible to keep the cool chamber 123 at lower temperature by using much more power output by the solar panel 101.

There is significance as follows in that the cool box configures a part of the solar energy utilization system.

In the case of the cool box, a compression rate of the compressor is markedly higher than that of the air conditioner. This is because temperature of the cool chamber needs to be lowered by several dozens of degrees from room temperature in the case of the cool box compared to the air conditioner in which temperature of a room may be merely lowered by around several degrees. Therefore, in the motor which drives the compressor of the cool box, significantly great torque fluctuation is to occur at a rotation cycle thereof. As has been described, there is a possibility that the torque fluctuation of the motor makes the operation of the motor unstable and causes a loss of synchronization. Accordingly, it may be said that it is reasonable to set the number of revolutions of the motor to be fixed like the conventional cool box that uses the solar panel as a power source in terms of stable operation of the motor because the maximum output power of the solar panel exceeds the power consumption of the motor in most parts of an output time zone of the solar panel.

Furthermore, the cool box which includes a configuration of increasing or decreasing the number of revolutions of the motor according to increase or decrease in the sunlight intensity radiated to the solar panel exerts an effect more than the aforementioned conventional cool box.

Since the solar panel is not able to generate power in night time, the compressor of the cool box has to be halted in night time. On the other hand, it is necessary to avoid that stored items such as foods and drugs after being cooled once are returned to temperature which is predetermined temperature or more even temporarily. This is a constraint which is not put on the air conditioner nor the pump. Therefore, it is very important that stored items such as foods and drugs and the cool storage agent, which are cooled in daytime, radiate cold heat in night time to thereby keep an inside of the cool chamber at predetermined temperature or less even in night time.

When it is set that the number of revolutions of the motor is increased or decreased according to increase or decrease in the sunlight intensity radiated to the solar panel, it is possible to prolong driving time of the motor by driving the motor even in morning and evening time zones where the sunlight intensity is weak. Moreover, in a daytime time zone where the sunlight intensity is strong, it is possible to cool the cool chamber powerfully by increasing the number of revolutions of the motor. This makes it possible to increase an amount of cold heat which is stored in the stored items and the cool storage agent to keep a great difference of temperature from a surrounding environment even in night time.

As is clear from the above, in the cool box which drives the compressor by the motor that operates with power output by the solar panel, by performing control to increase or decrease the number of revolutions of the motor according to increase or decrease in the sunlight intensity radiated to the solar panel, a special effect is exerted that temperature of food, drugs and the like stored in the cool box is able to be kept at predetermined temperature or less also in night time. Further, a special effect of managing with a relatively small solar panel is exerted.

In FIG. 4, the maximum output power of the solar panel and power usage do not match with each other at any point. As shown FIG. 2, this results from limiting the operation point a to the right side of the point cm and power transmission efficiency of the control unit 110 including the DC-DC converter 111 and the inverter 112 being not 100%.

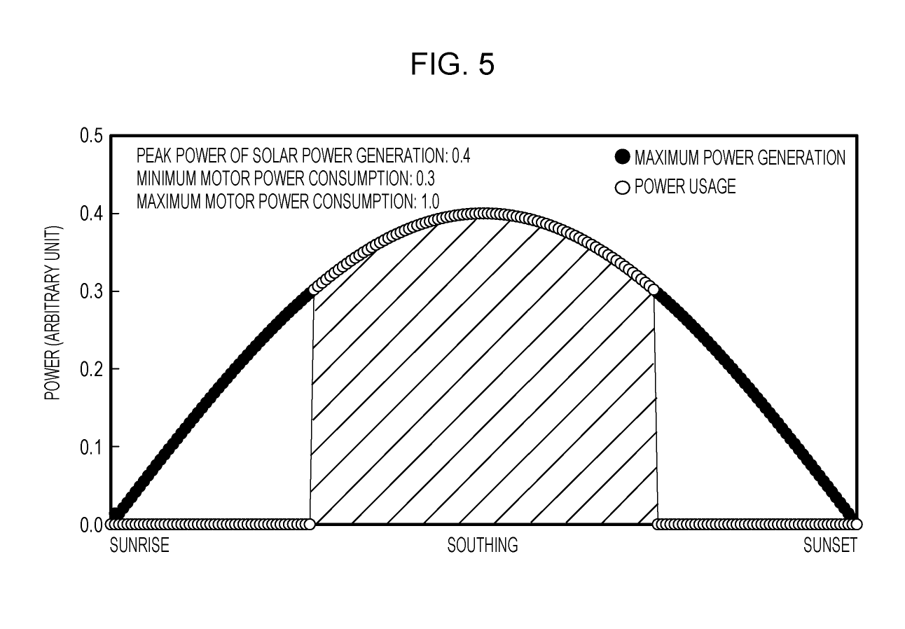

Description will be given what is a preferable relation between the maximum output power of the solar panel 101 and the maximum power consumption of the motor 122 based on FIG. 5 to FIG. 8.

As to the minimum number of revolutions and the maximum number of revolutions of the motor 122, the minimum number of revolutions is set as 1500 rpm and the maximum number of revolutions is set as 5000 rpm typically. A ratio of the minimum number of revolutions and the maximum number of revolutions is 3:10. When an approximation law that the power consumption is proportionate to the number of revolutions is applied with change in the motor power consumption by change in an environment or a heat load ignored, a ratio of the minimum power consumption and the maximum power consumption of the motor 122 is also 3:10.

FIG. 5 shows time change of maximum power generation (power generation at maximum power point) of the solar panel and power consumption (power usage) of the motor when peak power of power generation of the solar panel is 0.4, the maximum power consumption of the motor is 1.0, and the minimum power consumption of the motor is 0.3 (all numbers are index numbers). Note that, the peak power of power generation of the solar panel is the maximum power generation of the solar panel during southing of the sun.

In FIG. 5, the power generated by the solar panel is not able to be used at all over a long time period after sunrise and before sunset. This is because the power generation of the solar panel does not reach the minimum power consumption of the motor. A hatched-line part of FIG. 5 is a period in which power is usable and an area thereof represents a power usage amount.

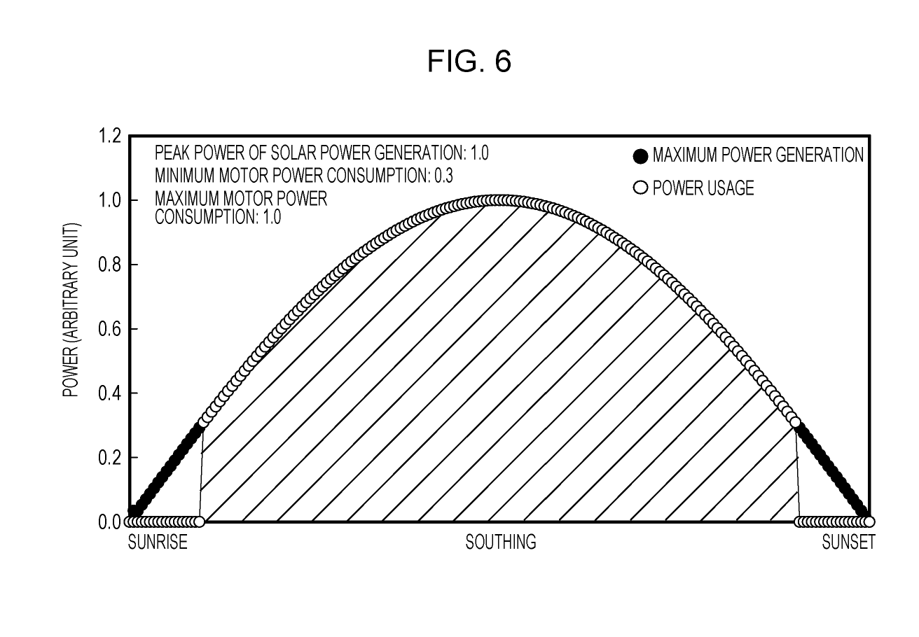

FIG. 6 shows time change of the maximum power generation of the solar panel and power usage of the motor when the peak power of power generation of the solar panel is 1.0, the maximum power consumption of the motor is 1.0, and the minimum power consumption of the motor is 0.3.

In FIG. 6, the motor starts operation promptly after sunrise and continues the operation immediately before sunset. The power usage amount indicated by the hatched-line part is larger compared to that of FIG. 5

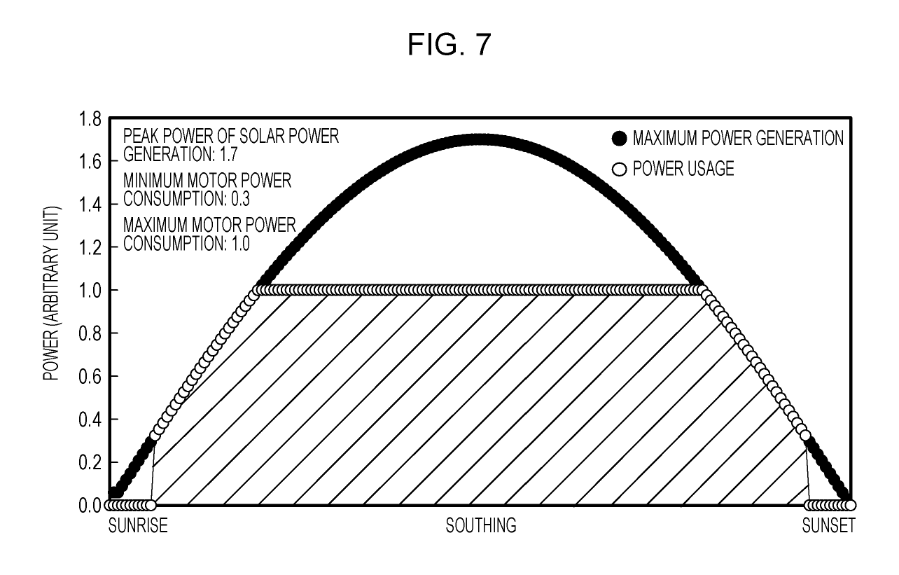

FIG. 7 shows time change of the maximum power generation of the solar panel and power usage of the motor when the peak power of power generation of the solar panel is 1.7, the maximum power consumption of the motor is 1.0 and the minimum power consumption of the motor is 0.3.

In FIG. 7, the motor starts operation promptly after sunrise and continues the operation immediately before sunset. The power usage amount indicated by the hatched-line part is larger compared to that of FIG. 5. However, the maximum power generation of the solar panel and the power usage of the motor are deviated greatly over a long time period before and after a southing time of the sun. This shows that a state where even though the solar panel can generate a lot of power, the motor is not able to utilize such amount of power has been continued for a long time.

Two points of presumptions exist in the graphs of FIG. 5 to FIG. 7. One point is that a direction of the solar panel is determined so that the power generation amount becomes maximum at the time of southing of the sun. The other one point is that transition of the power generation amount of the solar panel according to a time is represented by a sine function.

It is clear that the power consumption (power usage) of the motor can be increased as the solar panel becomes larger. However, a proportion occupied by the solar panel in total costs of the solar energy utilization system is large and the solar panel is preferably minimized as much as possible in order to suppressing the costs. Accordingly, an index showing about what proportion the power consumption (power usage) of the motor has in the maximum power amount which is generatable by the solar panel becomes important. This index is able to be defined as being obtained by dividing an integral value of the power consumption (power usage) of the motor (area of hatched-line part) by an integral value of the power generation of the solar panel, that is, as a total power usage amount/a total amount of generatable power in FIG. 5 to FIG. 7.

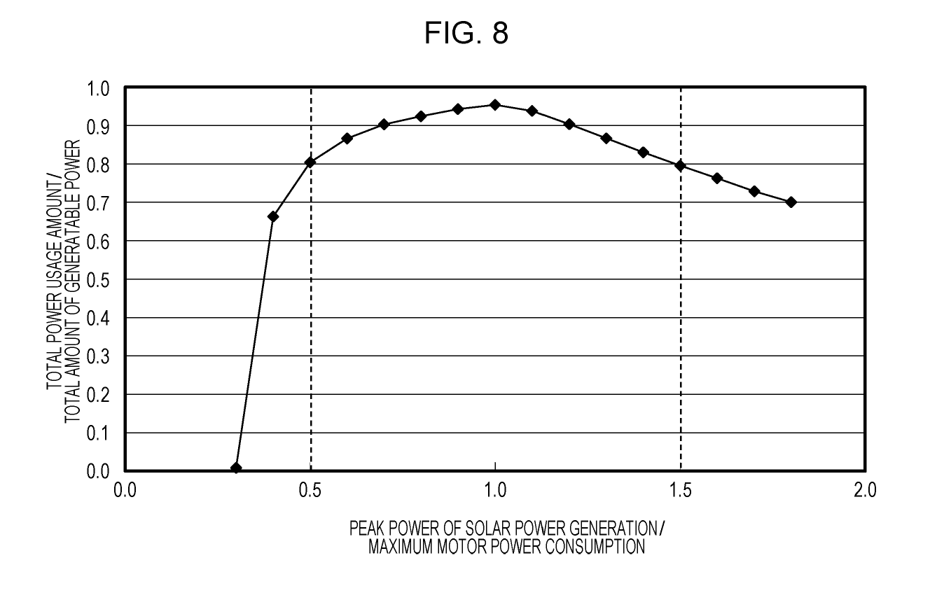

FIG. 8 shows change in a total power usage amount/a total amount of generatable power, when peak power of solar power generation/maximum motor power consumption changes. As is clear from FIG. 8, when peak power of solar power generation/maximum motor power consumption becomes below 0.5, a total power usage amount/a total amount of generatable power is reduced rapidly. This shows that the motor does not operate over a long time period in the morning and evening. On the other hand, when peak power of solar power generation/maximum motor power consumption exceeds 1.5 as well, a total power usage amount/a total amount of generatable power becomes below 80%.

When summing up the above, it is preferable that maximum power generation of the solar panel PS and maximum power consumption of the motor PM meet

0.5≦PS/PM≦1.5.

Thereby, the motor is able to utilize the power generated by the solar panel efficiently, so that it is possible to provide a high-performance cool box capable of sufficiently storing, in daytime, cold heat needed for cooling in night time while suppressing costs by reducing a size of the solar panel.

It is not preferable that temperature of the cool box rises in night time to exceed predetermined temperature even when the cool chamber is sufficiently cooled in daytime by increasing or decreasing the number of revolutions of the motor according to increase or decrease in the sunlight intensity radiated to the solar panel. When there are a sufficient amount of stored items in the cool chamber, with cold heat stored therein, the cool chamber is likely to be kept at the predetermined temperature or less also in night time. However, there are not always a sufficient amount of stored items.

Accordingly, the cool storage agent is preferably arranged in the cool chamber. This makes it possible to keep the inside of the cool chamber at the predetermined temperature or less reliably even in night time during which the solar panel is not able to generate power.

Alternatively, even when it was impossible to generate power sufficiently because of bad weather in daytime, it is possible to keep the cool chamber at the predetermined temperature or less until power generation becomes possible next time.

For example, as introduced as the configuration example which is able to realize the aforementioned “more preferable aspect”, when an installation place of the solar energy utilization system is set at a spot where a latitude is 12 degrees and an outside air temperature is 30° C., a solar panel having rated maximum output of 235 W is used, a capacity of the cool chamber is set as 200 litters, and as the cool storage agent, one which has latent heat of fusion of 230 kJ/kg is arranged in the cool chamber by 16.5 kg of weight, the cool chamber has been able to be kept at −20° C. or less for 38 hours after the motor stops operation. This shows that even when power have not been able to be generated for a whole day because of rainy weather, the cool chamber is able to be kept at sufficiently low temperature until the solar panel starts power generation at the time of next fine weather.

The solar energy utilization system 100 basically operates only with power supplied from the solar panel 101. Thereby, the solar energy utilization system 100 is able to be installed as a stand-alone system even in a place where there is no commercial power source. However, an output unit of an AC adapter connected to a commercial power source or an output unit of a secondary cell may be connected between the solar panel 101 and the DC-DC converter 111. This makes it possible to prevent the motor 122 during drive from losing synchronization and stopping even when the solar panel 101 causes significantly great output reduction.

The maximum number of revolutions of the motor 122 when being driven by power supplied from the AC adapter or the secondary cell is preferably lower than the maximum number of revolutions of the motor 122 when being driven only by power from the solar panel 101. Thereby, one having a small rating is enough for the AC adapter serving as an auxiliary power source of the solar panel 101 serving as a main power source. In the same manner, one having a small capacity is enough for the secondary cell serving as an auxiliary power source of the solar panel 101. Accordingly, it is possible to reduce costs of the solar energy utilization system 100.

By omitting the AC adapter and the secondary cell without dependence thereon, it is possible to simplify maintenance by substantially simplifying a circuit to reduce costs.

### (Details of One Method for Controlling Number of Revolutions of Motor)

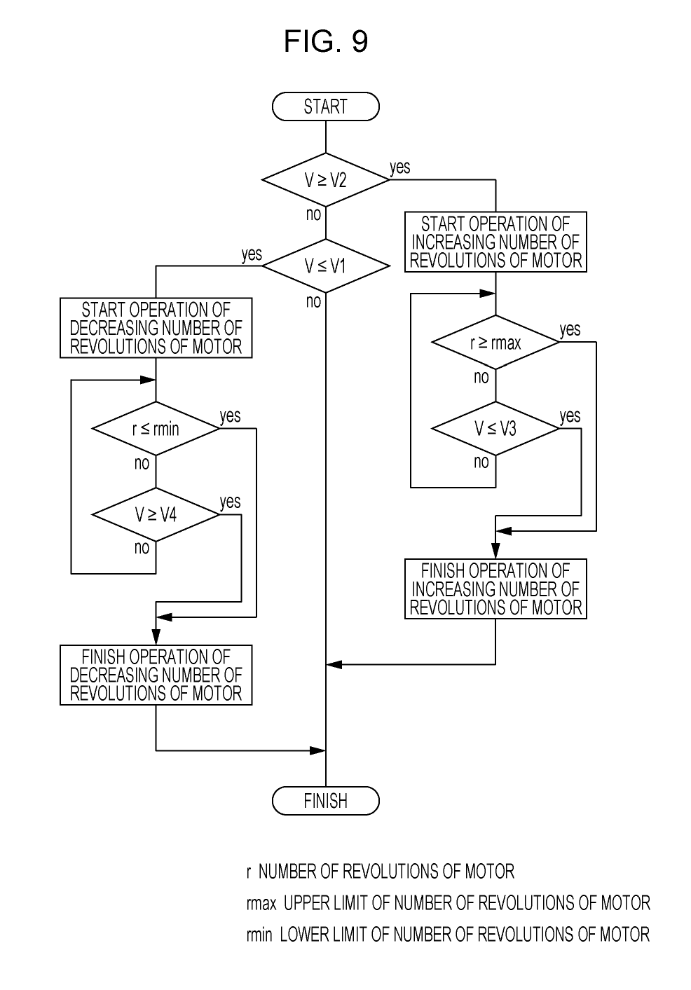

Description will be given for details of one method for controlling the number of revolutions of the motor 122 in the solar energy utilization system 100 based on FIG. 9 to FIG. 11.

A point of this method for controlling the number of revolutions of the motor resides in that an operation point in a P-V curve of the solar panel 101 is limited to be on a right side of a maximum power point. That is, it resides in that the solar output voltage is limited to voltage higher than output voltage at the maximum power point. This makes it possible to drive the motor 122 in a stable state. Moreover, it is possible to utilize the power generated by the solar panel 101 effectively as much as possible.

In the aforementioned method, it is fundamental to compare the maximum power output voltage Vm at the maximum power point of the solar panel 101 and the solar output voltage V at a certain point.

In this method, in order to determine the maximum power output voltage Vm, performances of the solar panel 101 may be grasped in advance to define the maximum power output voltage Vm. The solar output voltage V is able to be measured by the voltage sensor circuit 114.

When a step up ratio in the DC-DC converter 111 is turned out, the solar output voltage V may be estimated by measuring output voltage of the DC-DC converter 111. This method is particularly preferable when the DC-DC converter 111 performs stepping up to high voltage (for example, 380 V). The reason is that the inverter 112 to which high voltage is applied is also a control target of the control circuit unit 113, but is desired to be electrically separated from a low voltage portion on an input side of the DC-DC converter 111 or the like as far as possible. Thereby, for example, it is not necessary to make consideration of transmitting a signal from the voltage sensor 114 which is in the low voltage portion to the control circuit unit 113 through a photocoupler.

In the description below, fluctuation of motor power consumption due to fluctuation of the load of the motor is ignored. That is, it is set that when the number of revolutions of the motor and application voltage are defined, the power consumption of the motor is determined uniquely. Moreover, it is also ignored that the output performance of the solar panel changes according to temperature. Further, it is also ignored that the voltage Vm at which the solar panel outputs the maximum power fluctuates according to increase or decrease in the sunlight intensity.

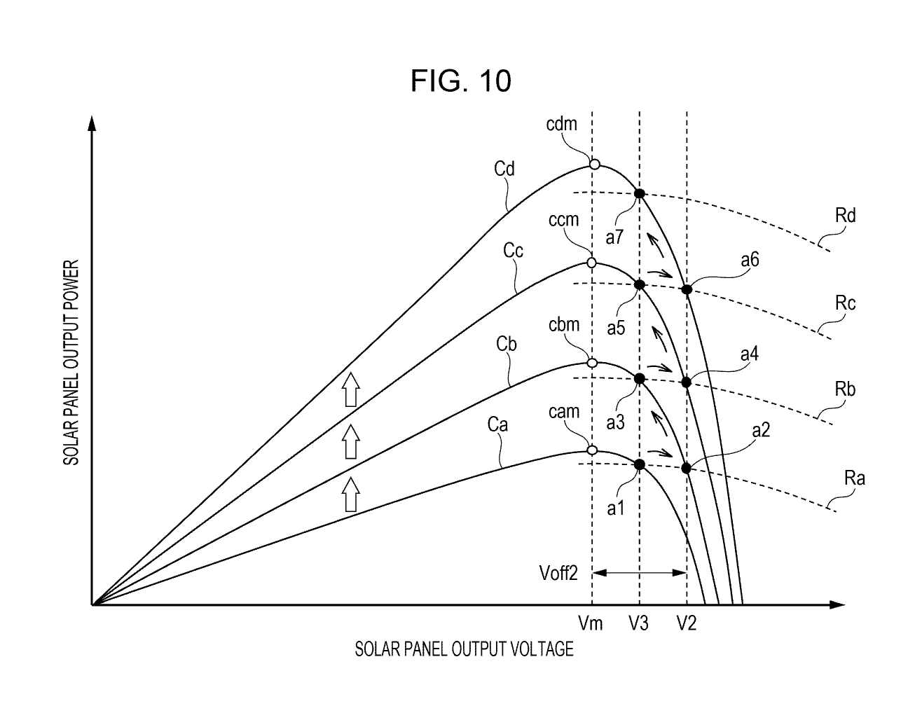

FIG. 9 is a flowchart of control of the number of revolutions of the motor. FIG. 10 represents movement of operation points when the sunlight intensity becomes strong increasingly after sunrise.

In FIG. 10, after a while after sunrise, the solar panel 101 is to have output performance of a P-V curve Ca and generate power by which the motor 122 is able to be driven with a minimum number of revolutions Ra. When P-V performance in the case of rotation of the motor 122 with Ra is set as a P-V curve Ra, the operation point of the solar panel 101 is positioned at an intersection a1 of the P-V curve Ca and the P-V curve Ra and the motor 122 rotates with the number of revolutions Ra. At this time, when the solar output voltage V is near V3, because of V1<V<V2, it is found from FIG. 9 that the number of revolutions of the motor 122 does not change.

When the sunlight intensity becomes strong gradually and the output performance of the solar panel 101 moves from the P-V curve Ca to the P-V curve Cb, an operation point a1 moves to an operation point a2 being on the P-V curve Ra. Thereby, since the solar output voltage V reaches V2, as found from FIG. 9, the number of revolutions of the motor 122 increases until the solar output voltage V reaches V3. At this time, the operation point a2 moves to an operation point a3 being on the P-V curve Cb. In the same manner below, the number of revolutions of the motor 122 increases to Rd which is the maximum number of revolutions and the operation point moves to a7.

When the sunlight intensity further increases and the output performance of the solar panel 101 further moves upward from a P-V curve Cd, the operation point a7 moves to a right side being on the P-V curve Rd, but the number of revolutions of the motor 122 does not increase any more.

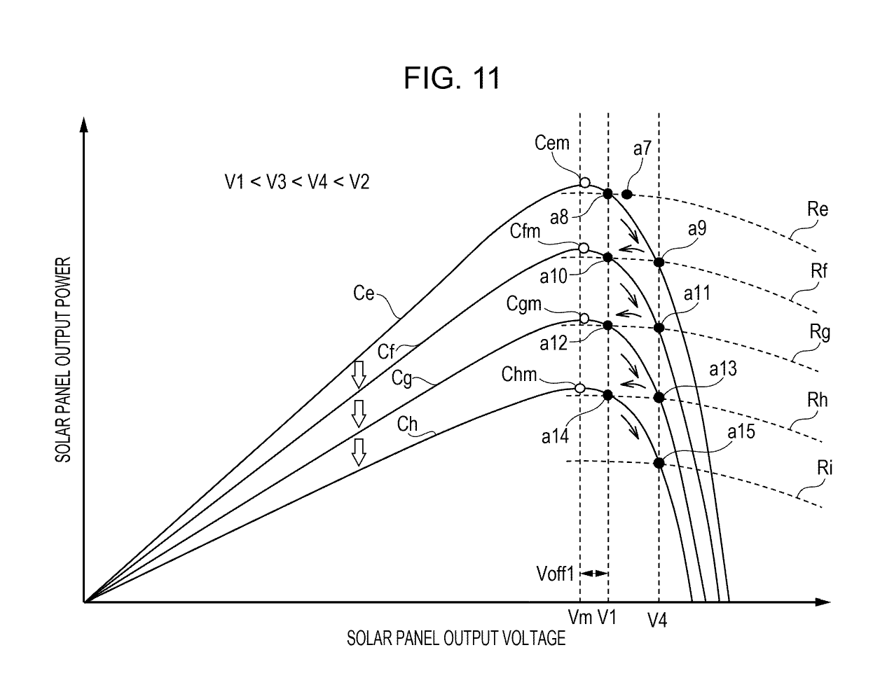

Next, description will be given for movement of operation points of the solar panel 101 when the sunlight intensity becomes weak gradually after southing of the sun with FIG. 11.

In FIG. 11, when the sunlight intensity decreases and the output performance of the solar panel 101 moves to a P-V curve Ce, the operation point a7 moves to a left side being on a P-V curve Re to move to an operation point a8. Here, since the solar output voltage V reaches V1, as found from FIG. 9, the number of revolutions of the motor 122 decreases until the solar output voltage V reaches V4. At this time, the operation point a8 moves to an operation point a9 being on the P-V curve Ce. In the same manner below, the number of revolutions of the motor 122 decreases to Ri (=Ra) which is the minimum number of revolutions and the operation point moves to a15.

When the sunlight intensity further decreases, the solar panel 101 becomes not able to generate power by which the motor 122 is able to be driven with the minimum number of revolutions Ri, so that the motor 122 stops.

In the aforementioned method for controlling motor rotation, the solar output voltage V is limited to voltage higher than the voltage Vm at which the solar panel 101 outputs the maximum power and is limited to meet V1<V<V2. In order to realize this, the number of revolutions of the motor 122 is decreased when a difference between the voltage

Vm at which the solar panel 101 outputs the maximum power and the output voltage V of the solar panel 101 is the predetermined offset voltage value Voff1 or less. Moreover, the number of revolutions of the motor 122 is increased when the difference between the voltage Vm at which the solar panel 101 outputs the maximum power and the solar output voltage V is the predetermined offset voltage value Voff2 or more.

By using the aforementioned method for controlling motor rotation, it is possible to keep the operation point of the solar panel 101 near the maximum power point while stabilizing the operation of the motor 122 of the solar energy utilization system 100. This makes it possible to utilize the power generated by the solar panel 101 effectively. Moreover, since such control is able to be performed only by measuring the solar output voltage V, it is possible to simplify the circuit.

The aforementioned V1 and V2 are able to be set as, for example, 32.5 V and 34 V when the solar panel having the maximum power output voltage Vm of 30 V is used. Note that, this value is just exemplification and does not limit the invention.

### (Details of Another Method for Controlling Number of Revolutions of Motor)

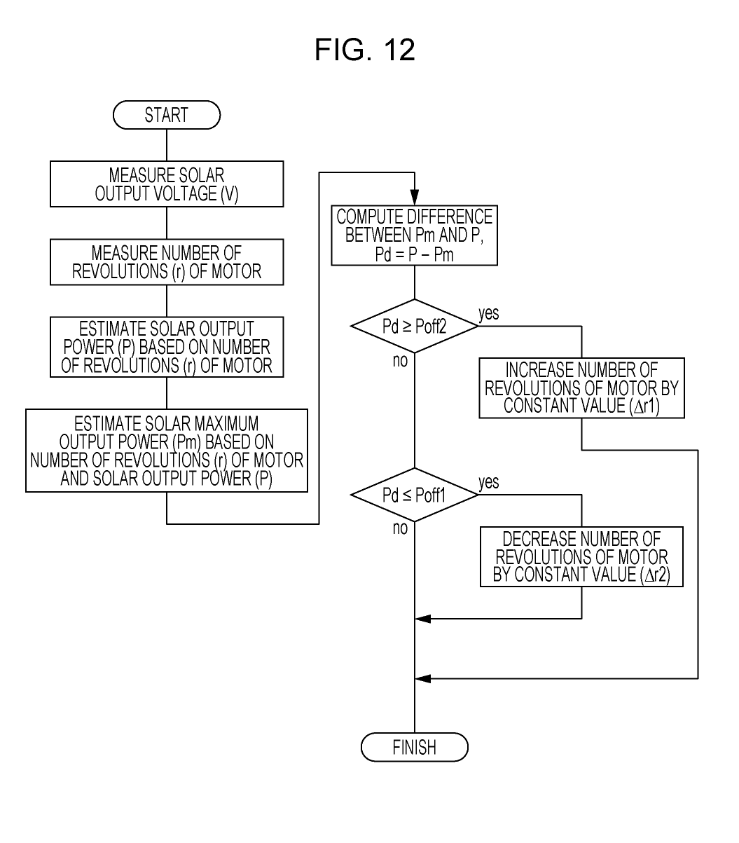

Description will be given for details of another method for controlling the number of revolutions of the motor 122 in the solar energy utilization system 100 based on FIG. 12 to FIG. 15.

In this method for controlling the number of revolutions of the motor as well, the operation point in the P-V curve of the solar panel 101 is limited to be on a right side of the maximum power point in the same manner as the one method for controlling the number of revolutions of the motor described above. That is, a point resides in that the solar output voltage is limited to voltage higher than the output voltage at the maximum power point. This makes it possible to drive the motor 122 in a stable state. Moreover, it is possible to utilize the power generated by the solar panel 101 effectively as much as possible.

A different point of this method for controlling the number of revolutions of the motor from the aforementioned one method is a point that the maximum power output voltage Vm at the maximum power point of the solar panel 101 and the solar output voltage V at a certain point are not compared, but the solar output power at the maximum power point Pm of the solar panel 101 at a certain point and the solar output power P at an operation point of the certain point are compared.

The solar output power P at the maximum power point changes according to the sunlight intensity even with the same solar panel, and therefore needs to be estimated from the solar output voltage V and the solar output power P at an operation point of a certain point.

The solar output power P at the certain point is obtained by estimating from the solar output voltage V and the number of revolutions r of the motor at the operation point of the certain point, estimating by actually measuring power consumption of the motor at the certain point, or actually measuring output power of the solar panel at the certain point.

In the description below, fluctuation of motor power consumption due to fluctuation of the load of the motor is ignored. That is, it is set that when the number of revolutions of the motor and application voltage are defined, the power consumption of the motor is determined uniquely. Moreover, it is also ignored that the output performance of the solar panel changes according to temperature. Further, it is also ignored that the voltage Vm at which the solar panel outputs the maximum power fluctuates according to increase or decrease in the sunlight intensity.

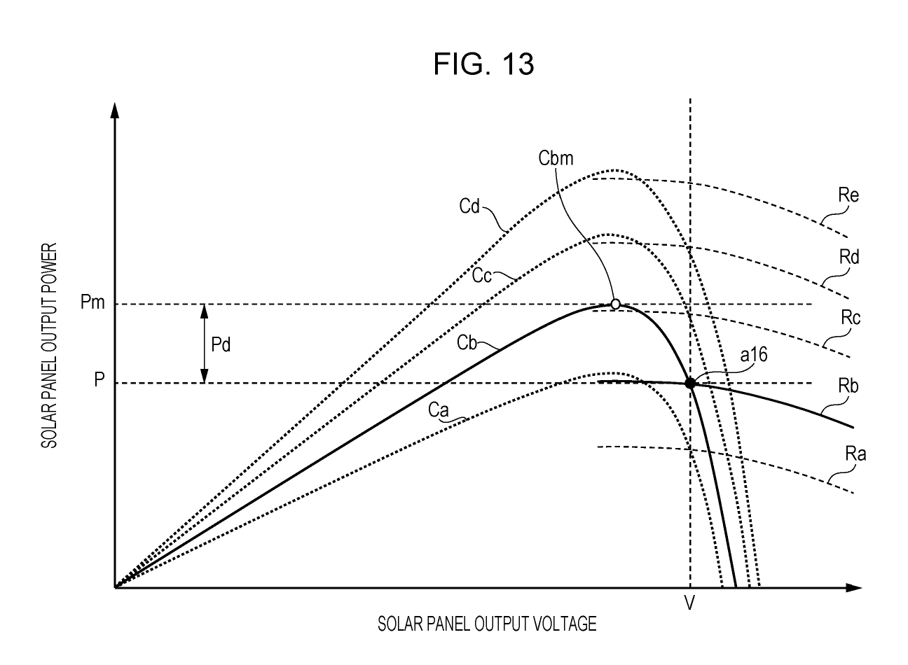

FIG. 12 is a flowchart of control of the number of revolutions of the motor. FIG. 13 is a view describing a method for estimating the solar output power at the maximum power point Pm.

As shown in FIG. 12, when the solar output power at the maximum power point Pm of the solar panel 101 at a certain point is to be obtained, the solar output voltage V and the number of revolutions r of the motor at the certain point are measured. The solar output voltage V is able to be measured by the voltage sensor circuit 114. The number of revolutions which is instructed by the control circuit unit 113 to the inverter 112 may be used as it is for the number of revolutions r of the motor.

Next, the solar output power P is estimated from the number of revolutions r of the motor. For this purpose, a relation between the number of revolutions of the motor and the motor power consumption and a relation between the motor power consumption and the solar output power P may be stored in the control unit 110 in advance. As is clear from FIG. 13, when the number of revolutions r of the motor is Rb and the solar output voltage is V, the operation point is at a16 and the solar output power P at this time is able to be obtained.

The solar output power P is able to be obtained from the number of revolutions r of the motor as described above, but may be obtained by actually measuring the motor power consumption or the solar output power P. For performing this, an ammeter and a voltmeter may be arranged at corresponding sites.

When the solar output voltage V and the solar output power P at a certain point are obtained with the aforementioned method, as shown in FIG. 13, the P-V curve of the solar panel 101 at the certain point and the solar output power at the maximum power point Pm are able to be estimated. By storing the P-V curve in each sunlight intensity of the solar panel which is connected, the P-V curve Cb of the solar panel 101 passing through an operation point a16 is able to be obtained uniquely, so that the solar output power at the maximum power point Pm is also able to be estimated.

Next, a difference Pd between the solar output power at the maximum power point Pm and the solar output power P is obtained. Pd indicates how much reserve the power generation capability of the solar panel has.

The number of revolutions of the motor is increased or decreased depending on magnitude of Pd. In the case of Pd Poff2, the number of revolutions of the motor is increased by a fixed value Δr1, and in the case of Pd Poff1, the number of revolutions of the motor is decreased by a fixed value Δr2. In the case of Poff2>Pd>Poff1, the number of revolutions of the motor is not changed.

The fixed value Δr1 preferably meets 100 rpm≦Δr1≦500 rpm. When the fixed value Δr1 meets 100 rpm≦Δr1≦500 rpm, an effect is achieved that the number of revolutions of the motor does not need to be changed excessively frequently. Moreover, an effect is achieved that the power output by the solar panel is able to be utilized sufficiently effectively by changing the number of revolutions of the motor at appropriate frequency. The fixed value Δr2 preferably meets 200 rpm≦Δr2≦1000 rpm. When the fixed value Δr2 meets 200 rpm≦Δr2, an effect is sufficiently achieved that the motor is driven stably even when rapid decrease in the power generation amount is caused. Moreover, when Δr2≦1000 rpm is met, an effect is achieved that the power output by the solar panel is able to be utilized sufficiently effectively by suppressing excessive reduction in the number of revolutions of the motor.

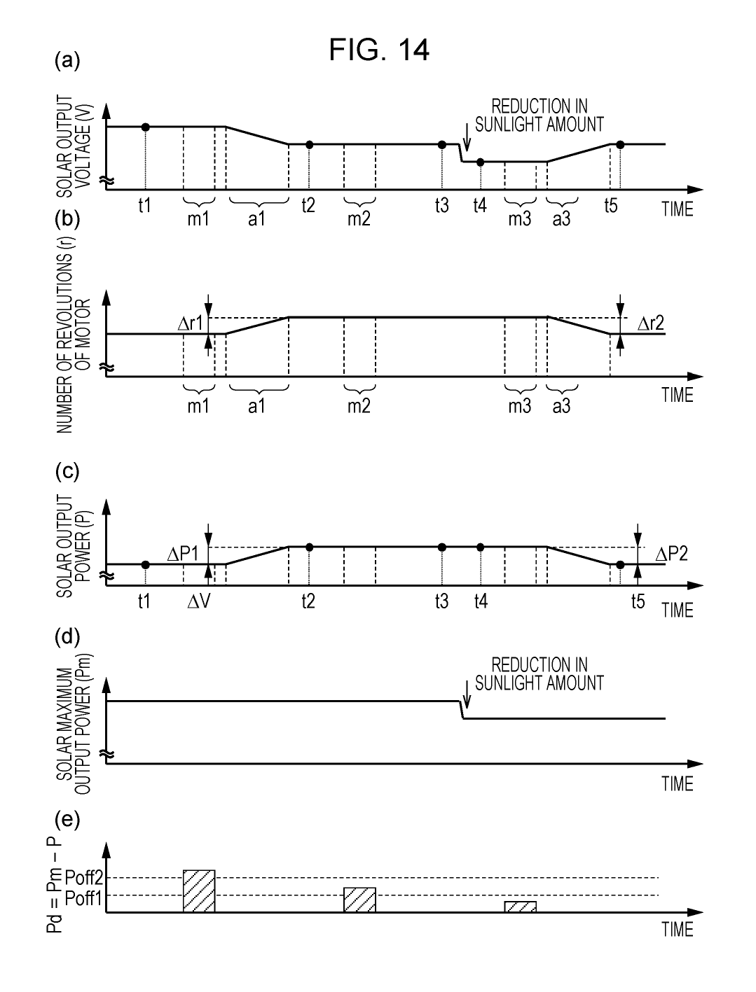

FIG. 14(a) to (e) are graphs showing each time change of the solar output voltage V, the number of revolutions r of the motor, the solar output power P, the solar maximum output power Pm and Pd (=Pm−P).

In FIG. 14, in measurement time periods shown with m1, m2 and m3, the solar output voltage V and the number of revolutions r of the motor are measured, and the solar output power P and the solar maximum output power Pm are obtained, from which Pd is obtained. In the measurement time period m1, Pd Poff2 is met and the number of revolutions r of the motor is increased by Δr1 in a time period a1. In the measurement time period m2, Poff2>Pd>Poff1 is met and the number of revolutions r of the motor is not changed. Then, reduction in the sunlight intensity is caused and the solar output voltage V and the solar maximum output power Pm decrease rapidly. As a result thereof, in the measurement time period m3, Pd≦Poff1 is met and the number of revolutions r of the motor is decreased by Δr2 in a time period a3.

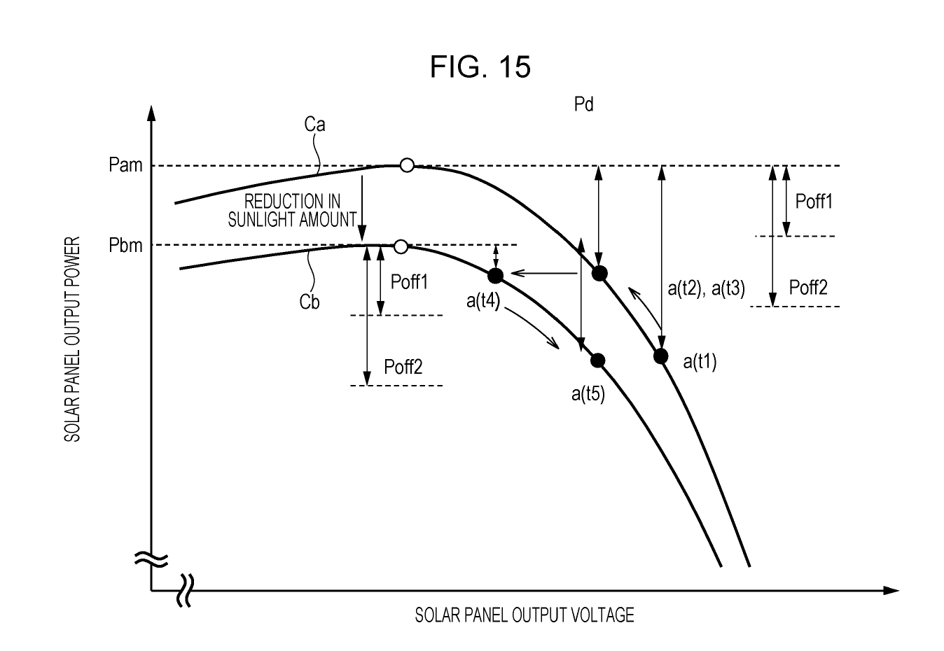

FIG. 15 shows transition of operation points of the solar panel at times t1 to t5 (a(t1) to a(t5)) of FIG. 14. It is found that control is performed so that Poff2>Pd>Poff1 is met.

When the aforementioned method for controlling motor rotation is used as well, it is possible to keep the operation point of the solar panel near the maximum power point while stabilizing the operation of the motor of the solar energy utilization system, thus making it possible to utilize the power generated by the solar panel effectively.

When the solar panel having rated output of 200 W is used, the aforementioned offset power values Poff1 and Poff2 are able to be set as, for example, 10 W and 20 W. Note that, these numerical values are persistently exemplification and do not limit the invention.

### Second Embodiment

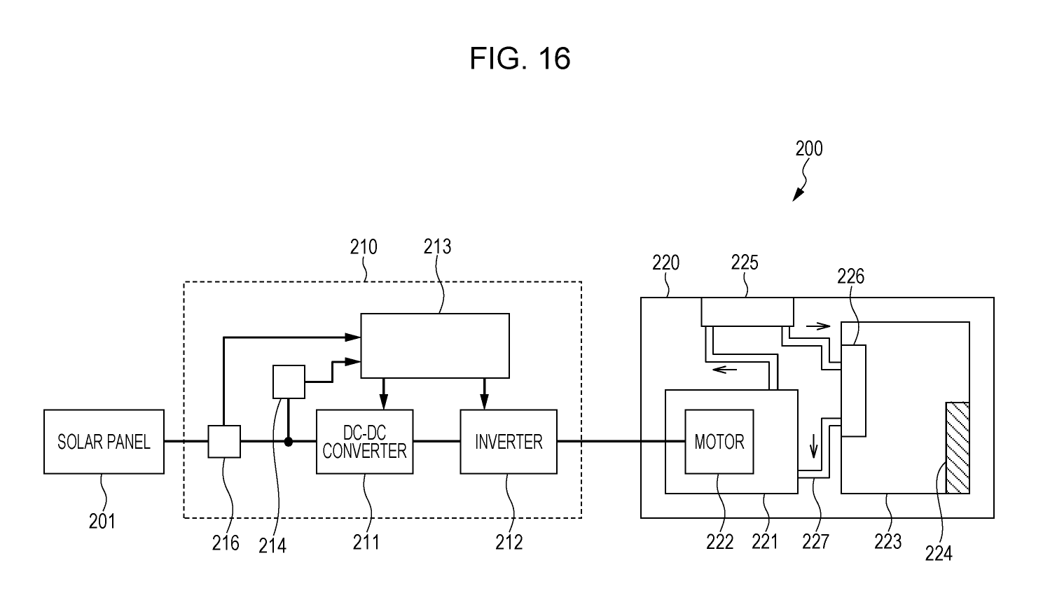

FIG. 16 is a block diagram of a solar energy utilization system according to a second embodiment of the present invention. A solar energy utilization system 200 of the second embodiment is different from the solar energy utilization system 100 of the first embodiment in the following respects. That is, the respects include that the temperature sensor 102 nor the temperature sensor circuit 115 which is included in the solar energy utilization system 100 is not included, that a current sensor circuit 216 which is not included in the solar energy utilization system 100 is included, and that a motor stall prevention device is different.

In the same manner as the case of the solar energy utilization system 100, the solar energy utilization system 200 includes a solar panel 201, a control unit 210 which receives power generated by the solar panel 201, and a cool box 220 which is driven by power output by the control unit 210.

The control unit 210 includes a DC-DC converter 211, an inverter 212, a control circuit unit 213, a voltage sensor circuit 214, and the current sensor circuit 216.

The cool box 220 includes a compressor 221 which is driven by a motor 222, a cool chamber 223, a cool storage agent 224 which is arranged in the cool chamber 223, a condenser 225 which receives a refrigerant with high temperature and high pressure which is discharged from the compressor 221, a cooler 226 which evaporates, inside thereof, the refrigerant which has performed heat radiation in the condenser 225 to thereby obtain cold heat and cool the cool chamber 223, and a refrigerant piping 227 which circulates the refrigerant from the compressor 221 to the condenser 225, from the condenser 225 to the cooler 226, and from the cooler 226 again to the compressor 221.

As the current sensor circuit 216, a circuit which flows current to a resistor and measures a potential difference of both ends of the resistor, a non-contact type circuit which detects a magnetic field made by current, or the like is usable.

Output voltage V of the solar panel 201 is measured by the voltage sensor circuit 214, and output current I of the solar panel 201 is measured by the current sensor circuit 216. From these output voltage V and output current I, output power P of the solar panel 201 is able to be obtained.

### (Motor Stall Prevention Device of Second Embodiment)

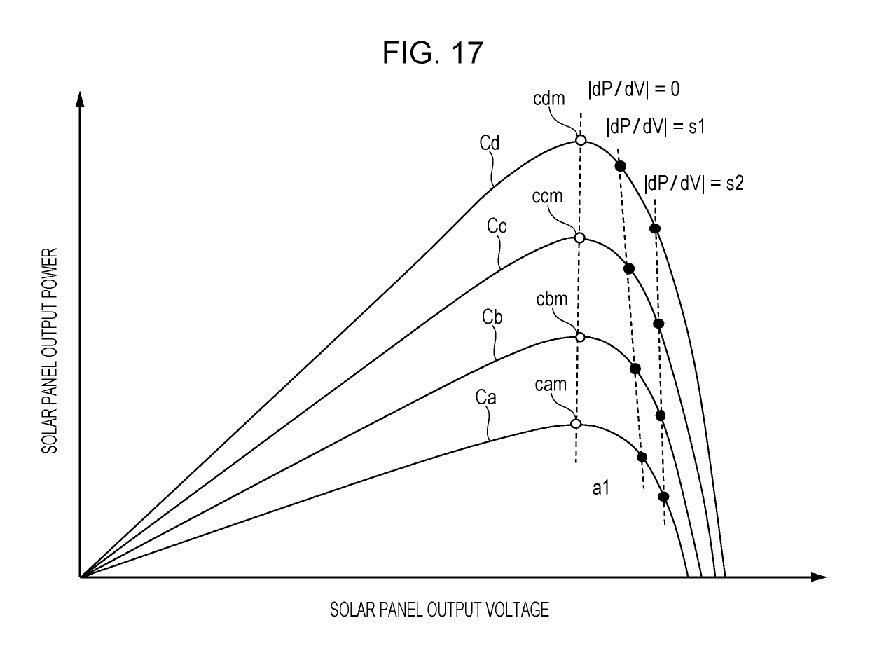

The solar energy utilization system 200 includes a motor stall prevention device which prevents the motor 222 during drive from stalling. The motor stall prevention device of the second embodiment is configured by the inverter 212, and the control circuit unit 213 which controls the inverter 212. This motor stall prevention device limits the output voltage of the solar panel 201 to voltage at which, when this output voltage is changed on a P-V curve, a change rate becomes negative. Basic operation principles thereof will be described based on FIG. 17.

In FIG. 17, output performances of a general solar panel in various sunlight intensity are drawn as P-V curves. In FIG. 17, maximum power points of P-V curves Ca, Cb, Cc and Cd are set as cam, cbm, ccm and cdm, respectively.

At the maximum power point of each P-V curve, based on a definition thereof, inclination of the P-V curve becomes zero, that is, dP/dV=0 is met at all times. Moreover, the inclination becomes positive (dP/dV>0) on a left side of the maximum power point (side where output voltage V is low) and the inclination becomes negative (dP/dV<0) on a right side of the maximum power point (side where output voltage V is high).

As described above, the motor stall prevention device of the solar energy utilization system 200 limits the output voltage of the solar panel 201 to voltage at which, when this output voltage is changed on the P-V curve, a change rate becomes negative (dP/dV<0). In other words, an operation point of the solar panel 201 is limited to be on the right side of the maximum power point. This makes it possible to avoid becoming unstable of the operation of the motor when being operated with the output voltage of the solar panel 201 as the voltage at which, when this output voltage is changed on the P-V curve, a change rate becomes positive (dP/dV>0). Accordingly, the solar energy utilization system 200 becomes possible to operate the motor 222 stably while utilizing power generation capability of the solar panel 201 effectively.

The change rate (dP/dV) of the output voltage of the solar panel 201 decreases monotonically as being close to the maximum power point and becomes 0 at the maximum power point. Therefore, by measuring the change rate (dP/dV), it is possible to easily estimate how far an operation point at a certain point is from a maximum operation point without knowing a position of the maximum operation point at all nor without reaching the maximum operation point.

Accordingly, even when a model of the solar panel 201 is changed to another one or performance of the solar panel 201 changes with change due to temperature or change with lapse of time, it is possible to continue stall prevention of the motor without changing setting or the like particularly.

The temperature sensor 102 nor the temperature sensor circuit 115 which exists in the solar energy utilization system 100 of the first embodiment is not included in the solar energy utilization system 200 of the second embodiment. This is because it is possible to cope with temperature change of the performance of the solar panel by measuring the output voltage V and the output power P of the solar panel 201 to measure the change rate (dP/dV) with the voltage sensor circuit 214 and the current sensor circuit 216.

In the motor stall prevention device of the solar energy utilization system 200, it is more preferable that a predetermined positive change rate s1 is set, from change of the output voltage ΔV of the solar panel 201 and change of the output power ΔP of the solar panel 201, the change rate ΔP/ΔV of the output power of the solar panel 201 is obtained, and then the motor 222 is controlled so that |ΔP/ΔV|>s1 is met. That is, the operation point is limited to be on a right side of a point at which |dP/dV|=s1 is met in FIG. 17.

By performing the control as described above, the same effect is able to be achieved as the case where the offset voltage value Voff1 is set and control is performed so that the solar output voltage V meets V>Vm+Voff1 (FIG. 2) in the first embodiment. That is, even when rapid output fluctuation is caused in the solar panel 201, it becomes possible to drive the motor 222 serving as the load stably.

As shown in FIG. 17, it is more preferable that a positive change rate s2 larger than s1 is further set and control is performed so that s2>|ΔP/ΔV|>s1 is met. That is, the operation point is limited to be on the right side of the point at which |dP/dV|=s1 is met as well as on a left side of a point at which |dP/dV|=s2 is met. By limiting the operation point to be at such positions, it is possible to operate the motor 222 stably while utilizing power generation capability of the solar panel 201 more effectively with a power generation amount of the solar panel 201 maintained at a high level.

Here, preferable values of the change rates s1 and s2 will be described. The change rates s1 and s2 are inclinations of the P-V curves, which change according to the output voltage and the output power of the solar panel, and therefore it is not appropriate to limit them as they are. However, shapes of the P-V curves of a general silicon-based solar cell become substantially universal by performing standardization. Here, the standardization is performed so that both of maximum power output voltage Vm and maximum power Pm of the solar panel become 1 (refer to table 2). Thereby, the shapes of the P-V curves become fixed regardless of a model of the solar panel. By using change rates s1×(Vm/Pm) and s2×(Vm/Pm) which are standardized instead of s1 and s2, it becomes possible to perform imitation with a dimensionless amount regardless of the model of the solar panel.

TABLE 2

| | | | | | | | | |
|---|---|---|---|---|---|---|---|---|
| P | Pm | 0.97 Pm | 0.95 Pm | 0.9 Pm | 0.8 Pm | 0.7 Pm | 0.6 Pm | 0.5 Pm |
| V | Vm | 1.05 Vm | 1.07 Vm | 1.1 Vm | 1.13 Vm | 1.15 Vm | 1.18 Vm | 1.2 Vm |
| Standardized | 0 | 1.0 | 1.4 | 2.3 | 3.8 | 4.8 | 5.7 | 6.7 |
| inclination | | | | | | | | |
| s(Vm/Pm) | | | | | | | | |

The standardized change rate s1×(Vm/Pm) preferably meets 1.0 s1×(Vm/Pm)≦5.7. When the standardized change rate s1×(Vm/Pm) meets 1.0≦s1×(Vm/Pm), an effect is sufficiently achieved that the motor 222 is stably driven against rapid output fluctuation of the solar panel 201. Moreover, when s1×(Vm/Pm)≦5.7 is met, an effect is achieved that it is possible to utilize the power output by the solar panel 201 sufficiently effectively.

The standardized change rate s2×(Vm/Pm) preferably meets s2×(Vm/Pm)≧s1×(Vm/Pm)+0.4 and s2×(Vm/Pm)≦6.7. When the standardized change rate s2×(Vm/Pm) meets s2×(Vm/Pm)≧s1×(Vm/Pm)+0.4, an effect is achieved that a number of revolutions of the motor 222 does not need to be changed excessively frequently. Moreover, when s2×(Vm/Pm)≦6.7 is met, an effect is achieved that it is possible to utilize the power output by the solar panel 201 sufficiently effectively.

### (Details of Method for Controlling Number of Revolutions of Motor)

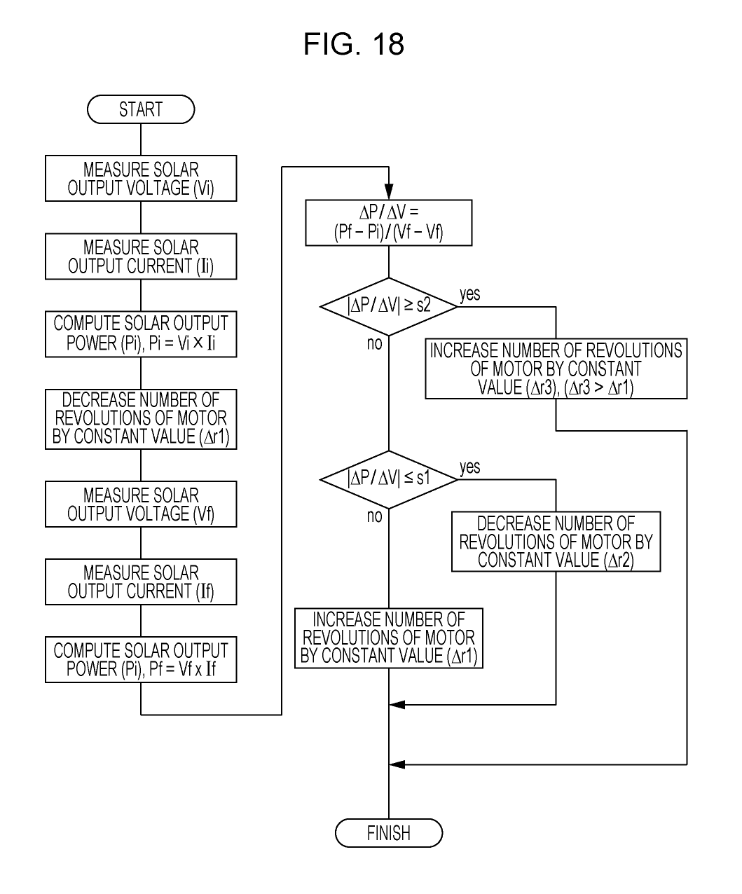

Description will be given for details of a method for controlling the number of revolutions of the motor 222 in the solar energy utilization system 200 based on FIG. 18 to FIG. 20.

A point of this method for controlling the number of revolutions of the motor resides in that the operation point in the P-V curve of the solar panel 201 is limited to voltage at which, when the solar output voltage V is changed, the change rate of the solar output power P becomes negative (dP/dV<0). This makes it possible to drive the motor 222 in a stable state. Moreover, it is possible to utilize the power generated by the solar panel 201 effectively as much as possible.

In the following description, it is ignored that output performance of the solar panel changes according to temperature. Further, it is also ignored that the voltage Vm at which the solar panel outputs the maximum power fluctuates according to increase or decrease in the sunlight intensity.

FIG. 18 is a flowchart of control of the number of revolutions of the motor. As shown in FIG. 18, a solar output voltage Vi and a solar output current Ii at a certain point are measured. By using a result thereof, a solar output power Pi at the certain point is calculated.

Next, the number of revolutions of the motor is decreased by a fixed value Δr1. The fixed value Δr1 is able to be set as, for example, 100 rpm, but not limited to this numerical value.

After slowing down of the motor is finished, solar output voltage Vf and solar output current If are measured. By using a result thereof, solar output power Pf after slowing down of the motor is calculated.

Next, a change rate of the solar output power to the solar output voltage before and after slowing down of the motor, that is, ΔP/ΔV=(Pf−Pi)/(Vf−Vi) is calculated. This change rate corresponds to inclination in the P-V curve, and is to be controlled so as to be negative in order to operate the motor stably. This change rate is close to zero as being close to a maximum power point, so that it is possible to estimate, from an absolute value thereof, how far an operation point is from the maximum power point.

In the procedure above, when the change rate ΔP/ΔV of the solar output power is obtained, the number of revolutions of the motor is decreased by the fixed value Δr1 so that ΔP becomes negative. In order to obtain the change rate ΔP/ΔV, the number of revolutions of the motor may be increased, that is, ΔP may be set to be positive, but it is preferable that ΔP is set to a negative value. This is because when the ΔP is negative, the operation point becomes far from the maximum power point, so that it is possible to prevent the operation of the motor from becoming unstable by measurement of the change rate ΔP/ΔV.

Next, the number of revolutions of the motor is changed according to magnitude of an absolute value of the change rate |ΔP/ΔV|. In the case of |ΔP/ΔV|≧s2, the number of revolutions of the motor is increased by a fixed value Δr3 (Δr3>Δr1). In the case of |ΔP/ΔV|<s1, the number of revolutions of the motor is further decreased by the fixed value Δr2. In the case of s2>|ΔP/ΔV|>s1, the number of revolutions of the motor is increased by the fixed value Δr1 to be returned to the number of revolutions before slowing down of the motor.

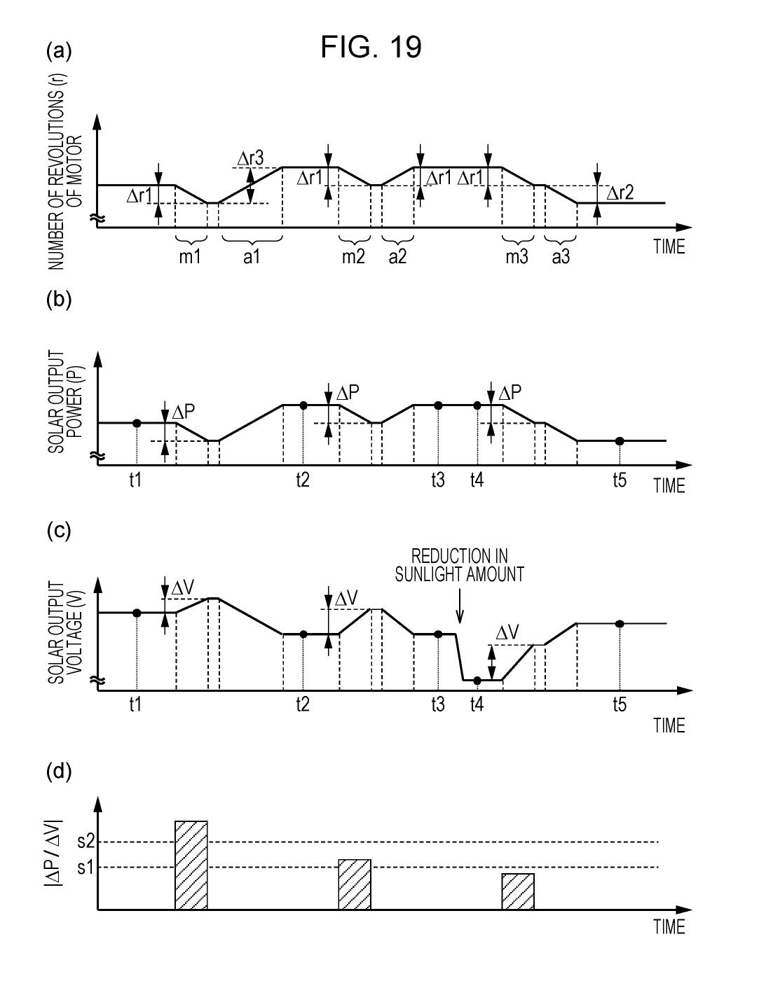

FIGS. 19(a) to (d) are graphs each showing the number of revolutions r of the motor, the solar output power P, the solar output voltage V and the change rate ΔP/ΔV of the solar output power.

In FIG. 19, in measurement time periods shown with m2 and m3, the number of revolutions r of the motor is decreased by Δr1 as well as the solar output voltage V and the solar output current I are measured before and after decreasing the number of revolutions of the motor, and by using a result thereof, the change rate ΔP/ΔV of the solar output power is obtained.

In the measurement time period m1, |ΔP/ΔV|≧s2 is met, and the number of revolutions r of the motor is increased by Δr3 (Δr3>Δr1) in a time period a1. As a result thereof, the number of revolutions of the motor is increased by Δr3−Δr1 compared to one before the measurement time period m1.

In the measurement time period m2, s2>|ΔP/ΔV|>s1 is met, and the number of revolutions r of the motor is increased by Δr1 in a time period a2. As a result thereof, the number of revolutions of the motor becomes the same as one before the measurement time period m2.

Then, reduction in the sunlight intensity is caused and the solar output voltage V decreases rapidly. As a result thereof, in the measurement time period m3, |ΔP/ΔV|≦s1 is met and the number of revolutions r of the motor is decreased by Δr2 in a time period a3. As a result thereof, the number of revolutions of the motor is decreased by Δr1+Δr2 compared to one before the measurement time period m3.

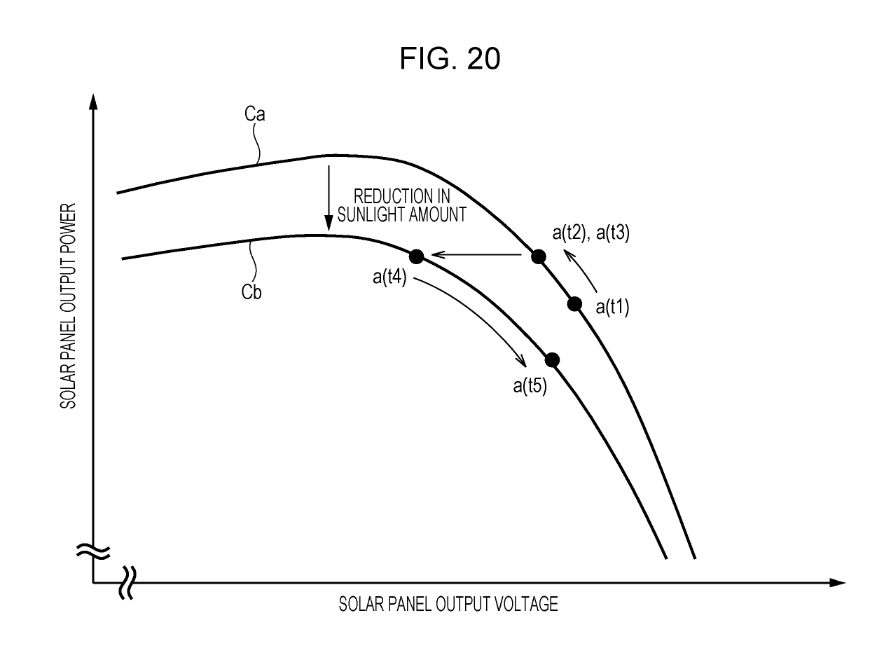

FIG. 20 shows transition of operation points of the solar panel at times t1 to t5 (a(t1) to a(t5)) of FIG. 19.

When the aforementioned method for controlling motor rotation is used as well, it is possible to keep the operation point of the solar panel near the maximum power point while stabilizing the operation of the motor of the solar energy utilization system, thus making it possible to utilize the power generated by the solar panel effectively.

As shown from FIG. 17, when the sunlight intensity is weak, inclination of the P-V curve becomes moderate entirely. Therefore, when s1 and s2 are fixed, the operation point of the solar panel when the sunlight intensity is weak is to be limited to be away from the maximum power point.

Accordingly, when the sunlight intensity is weak, a usage rate of the power generated by the solar panel is lowered. In order to prevent this, it is effective to multiply s1 and s2 by Pi or Pf for correction. Thereby, the operation point of the solar panel when the sunlight intensity is weak also approaches the maximum power point, thus making it possible to improve the usage rate of the power generated by the solar panel.

### Third Embodiment

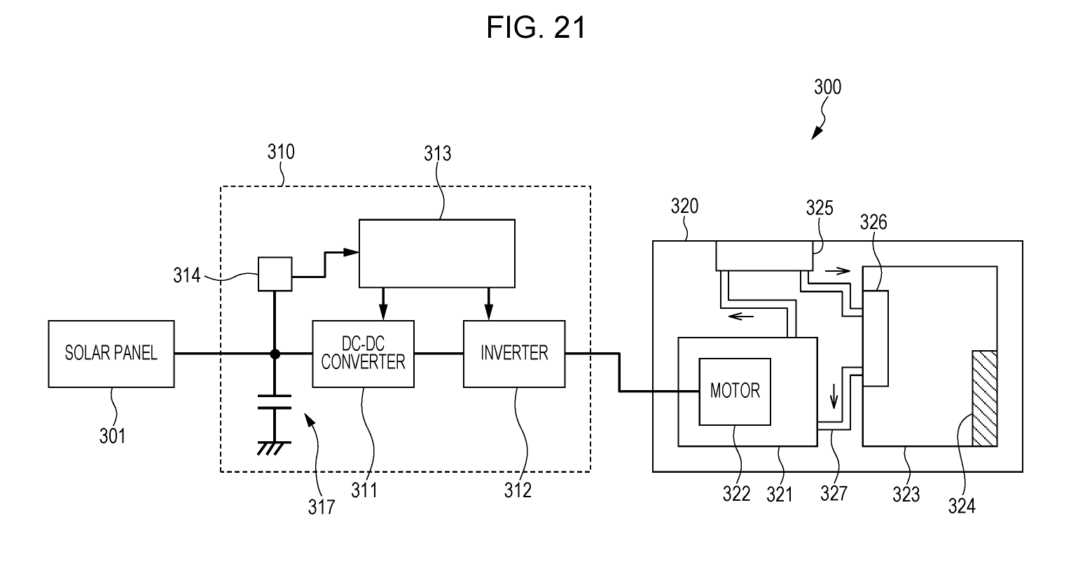

FIG. 21 is a block diagram of a solar energy utilization system according to a third embodiment of the present invention. A solar energy utilization system 300 of the third embodiment is different from the solar energy utilization system 100 of the first embodiment in the following respects. That is, the respects include that the temperature sensor 102 nor the temperature sensor circuit 115 which is included in the solar energy utilization system 100 is not included, that a large-capacity capacitor 317 which is not included in the solar energy utilization system 100 is included, and that a motor stall prevention device is different.

In the same manner as the case of the solar energy utilization system 100, the solar energy utilization system 300 includes a solar panel 301, a control unit 310 which receives power generated by the solar panel 301, and a cool box 320 which is driven by power output by the control unit 310.

The control unit 310 includes a DC-DC converter 311, an inverter 312, a control circuit unit 313, a voltage sensor circuit 314, and the capacitor 317.

The cool box 320 includes a compressor 321 which is driven by a motor 322, a cool chamber 323, a cool storage agent 324 which is arranged in the cool chamber 323, a condenser 325 which receives a refrigerant with high temperature and high pressure which is discharged from the compressor 321, a cooler 326 which evaporates, inside thereof, the refrigerant which has performed heat radiation in the condenser 325 to thereby obtain cold heat and cool the cool chamber 323, and a refrigerant piping 327 which circulates the refrigerant from the compressor 321 to the condenser 325, from the condenser 325 to the cooler 326, and from the cooler 326 again to the compressor 321.

### (Motor Stall Prevention Device of Third Embodiment)

The solar energy utilization system 300 includes a motor stall prevention device which prevents the motor 322 during drive from stalling. The motor stall prevention device of the third embodiment is configured by the capacitor 317 which is connected in parallel to the solar panel 301 or the motor 322 and stores power generated by the solar panel 301.

Due to existence of the capacitor 317, even when power consumption of the motor 322 exceeds maximum power generation of the solar panel 301, operation of the motor 322 does not become unstable immediately. When the power consumption of the motor 322 exceeds the maximum power generation of the solar panel 301, charge stored in the capacitor 317 decreases gradually and voltage of the capacitor 317 also decreases gradually. When this voltage decrease is detected by the voltage sensor circuit 314, the control circuit unit 313 instructs the inverter 312 to reduce the number of revolutions of the motor 322 to reduce the power consumption of the motor 322.

In this manner, since the solar energy utilization system 300 includes the capacitor 317 which is connected in parallel to the solar panel 301 and stores power generated by the solar panel 301 as the motor stall prevention device, it is possible to operate the motor 322 stably while utilizing power generation capability of the solar panel 301 effectively.

In FIG. 21, the capacitor 317 is connected to an output unit of the solar panel 301, but may be connected to an output unit of the DC-DC converter 311. In this case, the DC-DC converter 311 which is a voltage conversion device is to be inserted between the capacitor 317 and the solar panel 301, but in this case as well, the capacitor 317 is to be substantially connected in parallel to the solar panel 301 and store power generated by the solar panel 301.

A capacity of the capacitor 317 is preferably able to supply necessary power while the motor 322 slows down safely. The preferable capacity of the capacitor 317 will be described below.

The motor used for the cool box typically has elements of a maximum number of revolutions of 5000 rpm (power consumption is 150 W at this time), and a minimum number of revolutions of 1500 W (power consumption is 45 W at this time). Moreover, the motor used for the cool box is able to slow down safely normally when a slowing down speed is 60 rpm per second. The capacity of the capacitor 317 to be combined with such a motor is able to be considered as follows.

The number of revolutions of the motor of the cool box is normally 2000 rpm, and it frequently occurs that output of the solar panel is reduced and slowing down by 10% is needed, so that the capacitor 317 preferably has the capacity capable of dealing with such a situation. In this case, the output of the solar panel rapidly decreases from 60 W to 54 W and the motor takes 3.33 seconds to slow down from 2000 rpm (power consumption of 60 W) to 1800 W (power consumption of 54 W). In this period, a deficiency of the power from the solar panel becomes 10 watt-seconds. When the output voltage of the solar panel is 30 V, in order to store the power of 10 watt-seconds in the capacitor 317, the capacitor 317 needs to have the capacity of 22.2 mF.

A more preferable capacity of the capacitor 317 is obtained as follows. It is set that when the motor rotates at the maximum number of revolutions of 5000 rpm (power consumption of 150 W), power supply from the solar panel becomes zero. At this time, it requires 60 seconds for the motor to slow down to the minimum number of revolutions of 1500 rpm (power consumption of 45 W) safely. At this time, the power consumed by the motor is 5850 watt-seconds, and when the output voltage of the solar panel 317 is 30 V, the capacitor 317 needs the capacity of 13 F.

An upper limit value of the capacity of the capacitor 317 is preferably set as 100 F in consideration of costs and a volume.

When an amount of power stored in the capacitor 317 or the capacity of the capacitor 317 is set to be in the aforementioned range, it is possible to exert an effect of the motor stall prevention sufficiently.

Since the capacitor 317 needs to have a large capacity, an electric double-layer capacitor is preferably used.

### Fourth Embodiment

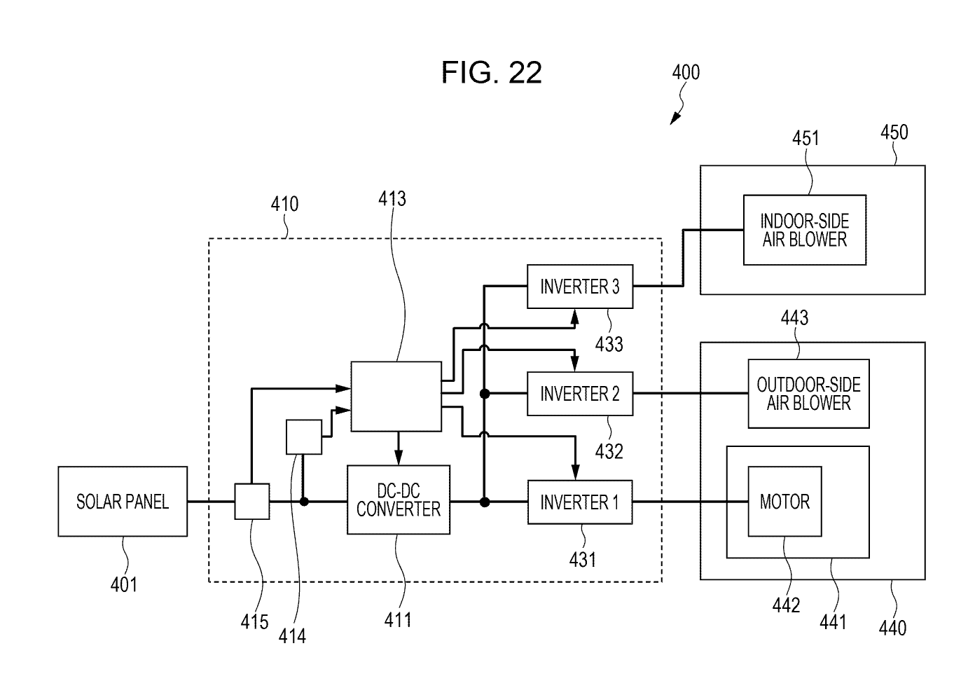

FIG. 22 is a block diagram of a solar energy utilization system according to a fourth embodiment of the present invention.

As shown in FIG. 22, a solar energy utilization system 400 according to the fourth embodiment includes a solar panel 401, a control unit 410 which receives power generated by the solar panel 401, and outdoor equipment 440 and indoor equipment 450 of an air conditioner, which are driven by power output from the control unit 410.

The control unit 410 includes a DC-DC converter 411, a control circuit unit 413, a voltage sensor circuit 414, a current sensor 415, and three inverters 431, 432 and 433.

The outdoor equipment 440 of the air conditioner includes a compressor 441 which is driven by a motor 442 and an outdoor-side air blower 443.

The indoor equipment 450 of the air conditioner includes an indoor-side air blower 451.

Note that, a condenser which receives a refrigerant with high temperature and high pressure which is discharged from the compressor 441 is arranged in the outdoor equipment 440 and a cooler which evaporates, inside thereof, the refrigerant which has performed heat radiation in the condenser to thereby obtain cold heat is arranged in the outdoor equipment 450, both of which are not shown.

The inverters 431, 432 and 433 drive the motor 442, the outdoor-side air blower 443 and the indoor-side air blower 451, respectively. The control circuit unit 413 controls the DC-DC converter 411 and the inverters 431, 432 and 433 integrally.

### (Motor Stall Prevention Device of Fourth Embodiment)

The solar energy utilization system 400 includes a motor stall prevention device which prevents the motor 442 during drive from stalling. The motor stall prevention device of the fourth embodiment is configured by the inverter 431, and the control circuit unit 413 which controls the inverter 431. This motor stall prevention device limits output voltage of the solar panel 401 to voltage at which, when this output voltage is changed on a P-V curve, a change rate becomes negative, to thereby prevent the motor 442 during drive from stalling, in the same manner as the motor stall prevention device of the second embodiment.

### Fifth Embodiment

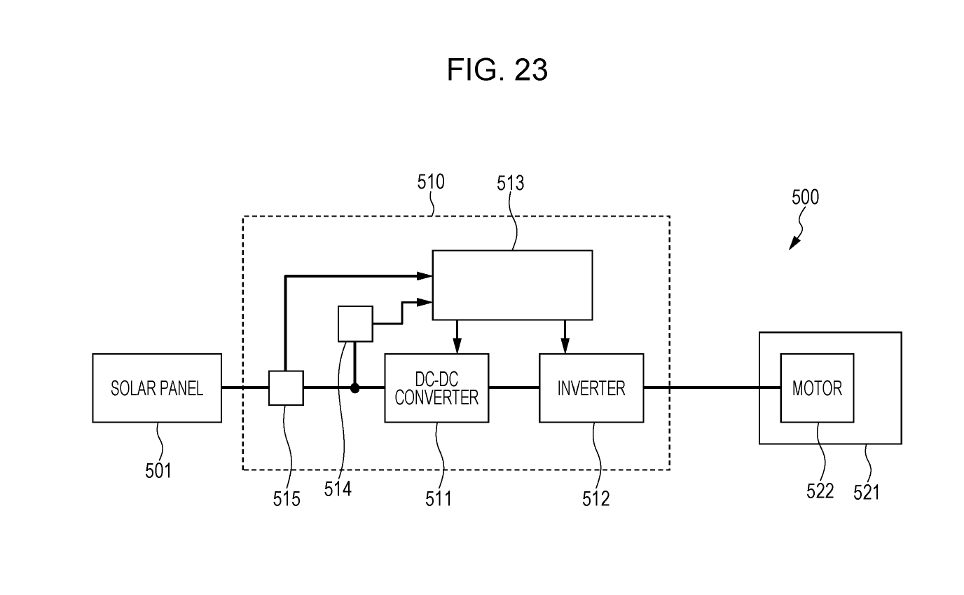

FIG. 23 is a block diagram of a solar energy utilization system according to a fifth embodiment of the present invention.

As shown in FIG. 23, a solar energy utilization system 500 according to the fifth embodiment includes a solar panel 501, a control unit 510 which receives power generated by the solar panel 501, and a pump 521 which is driven by power output from the control unit 510. The pump 521 is driven by a motor 522

The control unit 510 includes a DC-DC converter 511, an inverter 512, a control circuit unit 513, a voltage sensor circuit 514, and a current sensor 515.

### (Motor Stall Prevention Device of Fifth Embodiment)

The solar energy utilization system 500 includes a motor stall prevention device which prevents the motor 522 during drive from stalling. The motor stall prevention device of the fifth embodiment is configured by the inverter 512, and the control circuit unit 513 which controls the inverter 512. This motor stall prevention device limits output voltage of the solar panel 501 to voltage at which, when this output voltage is changed on a P-V curve, a change rate becomes negative, to thereby prevent the motor 522 during drive from stalling, in the same manner as the motor stall prevention device of the second embodiment.

As above, though embodiments of the present invention have been described, the range of the present invention is not limited thereto. They can be carried out with various alterations without departing from the gist of the invention.

### INDUSTRIAL APPLICABILITY

The present invention is able to be widely utilized for a solar energy utilization system.

### REFERENCE SIGNS LIST

100 solar energy utilization system
101 solar panel
102 temperature sensor
110 control unit
111 DC-DC converter
112 inverter
113 control circuit unit
114 voltage sensor circuit
115 temperature sensor circuit
120 cool box
121 compressor
122 motor
123 cool chamber
124 cool storage agent
125 condenser
126 cooler
127 refrigerant piping
200 solar energy utilization system
201 solar panel
210 control unit
211 DC-DC converter
212 inverter
213 control circuit unit
214 voltage sensor circuit
216 current sensor circuit
220 cool box
221 compressor
222 motor
223 cool chamber
224 cool storage agent
225 condenser
226 cooler
227 refrigerant piping
300 solar energy utilization system
301 solar panel
310 control unit
311 DC-DC converter
312 inverter
313 control circuit unit
314 voltage sensor circuit
317 capacitor
320 cool box
321 compressor
322 motor
323 cool chamber
324 cool storage agent
325 condenser
326 cooler
327 refrigerant piping
400 solar energy utilization system
401 solar panel
410 control unit
411 DC-DC converter
413 control circuit unit
414 voltage sensor circuit
415 current sensor circuit
431, 432, 433 inverter
440 outdoor equipment of air conditioner
441 compressor
442 motor
443 outdoor-side air blower
450 indoor equipment of air conditioner
451 indoor-side air blower
500 solar energy utilization system
501 solar panel
510 control unit
511 DC-DC converter
512 inverter
513 control circuit unit
514 voltage sensor circuit
515 current sensor circuit
521 pump
522 motor

1. A solar energy utilization system, configured as follows:
a solar panel;
a motor that is driven by power output by the solar panel; and
a motor stall prevention device that prevents the motor during drive from stalling are included, and
as the motor stall prevention device, any of following devices is selected:
(a) a motor stall prevention device that limits output voltage of the solar panel to voltage higher than voltage at which the solar panel outputs maximum power at the point in time;
(b) a motor stall prevention device that limits output voltage of the solar panel to voltage at which, when the output voltage is changed on a P-V curve, a change rate becomes negative; and
(c) a motor stall prevention device that is configured by a capacitor which is connected in parallel to the solar panel and stores power output by the solar panel.

2. The solar energy utilization system according to claim 1, configured as follows:
as the motor stall prevention device, the motor stall prevention device that performs control to limit the output voltage of the solar panel to voltage higher than the voltage at which the solar panel outputs the maximum power at the point in time is selected, and
the motor stall prevention device performs control so that output voltage V of the solar panel meets
V>Vm+Voff1
with respect to maximum power output voltage Vm at which the solar panel outputs the maximum power at the point in time and a predetermined positive offset voltage value Voff1.

3. The solar energy utilization system according to claim 2, configured as follows:
the motor stall prevention device decreases a number of revolutions of the motor when a difference between the maximum power output voltage Vm and the output voltage V is the offset voltage value Voff1 or less, and
increases the number of revolutions of the motor when the difference between the maximum power output voltage Vm and the output voltage V is a predetermined positive offset voltage value Voff2 (>Voff1) or more.

4. The solar energy utilization system according to claim 2, configured as follows:
the offset voltage value Voff1 meets 0.18×Vm≧Voff1≧0.05×Vm.

5. The solar energy utilization system according to claim 3, configured as follows:
the offset voltage value Voff2 meets Voff2≧Voff1+0.02×Vm and Voff2≦0.2×Vm.

6. The solar energy utilization system according to claim 2, configured as follows:
a thermometer that measures temperature of the solar panel is included, and a control circuit of the motor stall prevention device performs motor stall prevention control by correcting the maximum output voltage Vm according to the temperature measured by the thermometer.

7. The solar energy utilization system according to claim 1, configured as follows:
as the motor stall prevention device, the motor stall prevention device that performs control to limit the output voltage of the solar panel to voltage higher than the voltage at which the solar panel outputs the maximum power at the point in time is selected, and
the motor stall prevention device performs control so that output power P of the solar panel that is obtained by estimation or by actual measurement of a number of revolutions of the motor meets
P<Pm−Poff1
with respect to maximum output power Pm of the solar panel at the point in time, which is estimated by using the number of revolutions of the motor and the output power of the solar panel, and a predetermined positive offset power value Poff1.

8. The solar energy utilization system according to claim 7, configured as follows:
the motor stall prevention device decreases the number of revolutions of the motor when a difference between the maximum output power Pm and the output power P is the offset power value Poff1 or less, and
increases the number of revolutions of the motor when the difference between the maximum output power Pm and the output power P is a predetermined power value Poff2 or more.

9. The solar energy utilization system according to claim 7, configured as follows:
the offset power value Poff1 meets 0.4 Pm≧Poff1≧0.03×Pm.

10. The solar energy utilization system according to claim 8, configured as follows:
the offset power value Poff2 meets Poff2≧Poff1+0.02×Pm and Poff2≦0.5 Pm.

11. The solar energy utilization system according to claim 7, configured as follows:
a thermometer that measures temperature of the solar panel is included, and a control circuit of the motor stall prevention device performs motor stall prevention control by correcting the maximum output power Pm according to the temperature measured by the thermometer.

12. The solar energy utilization system according to claim 1, configured as follows:
as the motor stall prevention device, the motor stall prevention device that performs control to limit the output voltage of the solar panel to voltage at which, when the output voltage is changed on the P-V curve, the change rate becomes negative is selected, and
the motor stall prevention device obtains a change rate ΔP/ΔV of output power of the solar panel from change in the output voltage ΔV of the solar panel and change in the output power ΔP of the solar panel when power consumption of the motor is changed, and
performs control so that, with respect to a predetermined positive change rate s1, an absolute value of the change rate ΔP/ΔV meets

|ΔP/ΔV|>s1.

13. The solar energy utilization system according to claim 12, configured as follows:
the motor stall prevention device decreases a number of revolutions of the motor when the absolute value of the change rate ΔP/ΔV is the change rate s1 or less, and
increases the number of revolutions of the motor when the absolute value of the change rate ΔP/ΔV is a predetermined positive change rate s2 or more, which is larger than the change rate s1.

14. The solar energy utilization system according to claim 12, configured as follows:
the change rate s1 meets 1.0≦s1×(Vm/Pm)≦5.7 (where Vm and Pm are maximum power output voltage and maximum power of the solar panel at the point in time, respectively).

15. The solar energy utilization system according to claim 13, configured as follows:
the change rate s2 meets s2×(Vm/Pm)≧s1×(Vm/Pm)+0.4 and s2×(Vm/Pm)≦6.7 (where Vm and Pm are maximum power output voltage and maximum power of the solar panel at the point in time, respectively).

16. The solar energy utilization system according to claim 12, configured as follows:
ΔP when the change rate ΔP/ΔV is obtained is set as a negative value.

17. The solar energy utilization system according to claim 2, configured as follows:
the motor is an inverter control motor, and the motor stall prevention device is configured by an inverter and a control circuit of the inverter.

18. The solar energy utilization system according to claim 2, configured as follows:
the motor is a direct current commutator motor, and the motor stall prevention device is configured by a DC-DC converter and a control circuit of the DC-DC converter.

19. The solar energy utilization system according to claim 1, configured as follows:
as the motor stall prevention device, the motor stall prevention device that is configured by the capacitor which is connected in parallel to the solar panel and stores power generated by the solar panel is selected, and
a capacity C of the capacitor is
22.2 mF or more and 100 F or less.

20. A cool box, an air conditioner or a pump included in the solar energy utilization system according to claim 1 by including the motor and the motor stall prevention device.
